(19) United States
(12) Patent Application Publication
(10) Pub. No.: US 2022/0050051 A1
(43) Pub. Date: Feb. 17, 2022

(54) METHODS FOR DETECTING END-POINTS FOR CLEANING PROCESSES OF AEROSPACE COMPONENTS

(71) Applicant: Applied Materials, Inc., Santa Clara, CA (US)

(72) Inventors: Abhishek MANDAL, Maharashtra (IN); Lance A. SCUDDER, Sunnyvale, CA (US); David Alexander BRITZ, San Jose, CA (US); Kenichi OHNO, Sunnyvale, CA (US); Nitin DEEPAK, Mumbai (IN); Prerna Sonthalia GORADIA, Mumbai (IN); Ankur KADAM, Mumbai (IN)

(21) Appl. No.: 17/401,061

(22) Filed: Aug. 12, 2021

(30) Foreign Application Priority Data
Aug. 13, 2020 (IN) 202041034818

(51) Int. Cl. G01N 21/33; B08B 3/10; B08B 3/12; C11D 1/12; C11D 1/00; C11D 1/37

(52) U.S. Cl. CPC G01N 21/33; B08B 3/102; B08B 3/12; B08B 2203/007; C11D 1/004; C11D 1/37; C11D 1/12

(57) ABSTRACT

Embodiments of the present disclosure generally relate to methods for detecting end-points of cleaning processes for aerospace components containing corrosion. The method includes exposing the aerospace component to a first solvent, exposing the aerospace component to a first water rinse, and analyzing a first aliquot of the first water rinse by absorbance spectroscopy to determine an intermediate solute concentration in the first aliquot, where the intermediate solute concentration is greater than a reference solute concentration. The method further includes exposing the aerospace component to an aqueous cleaning solution to remove corrosion from the aluminum oxide layer, exposing the aerospace component to a second solvent, and exposing the aerospace component to a second water rinse, and analyzing a second aliquot of the second water rinse by absorbance spectroscopy to determine a post-clean solute concentration in the second aliquot, where the post-clean solute concentration is less than the intermediate solute concentration.

### CROSS-REFERENCE TO RELATED APPLICATIONS

This application claims benefit to Indian Prov. Appl. No. 202041034818, filed on Aug. 13, 2020, which is herein incorporated by reference.

### BACKGROUND

### Field

Embodiments of the present disclosure generally relate to cleaning and metrology processes, and in particular to cleaning processes for aerospace components and the end-point detection of such cleaning processes.

### Description of the Related Art

Aerospace components, such as turbine engines, typically have parts or components which corrode or degrade over time due to being exposed to hot gases and/or reactive chemicals (e.g., acids, bases, or salts). Such aerospace components are often protected by a thermal and/or chemical barrier coating. The current coatings used on airfoils exposed to the hot gases of combustion in gas turbine engines for both environmental protection and as bond coats in thermal barrier coating (TBC) systems include both diffusion aluminides and various metal alloy coatings. These coatings are applied over substrate materials, typically nickel-based superalloys, to provide protection against oxidation and corrosion attack. These protective coatings are formed on the substrate in a number of different ways and can include a metal aluminide layer and/or aluminum oxide layer. For example, a nickel aluminide layer may be grown as an outer coat on a nickel superalloy by simply exposing the substrate to an aluminum rich environment at elevated temperatures. The aluminum diffuses into the substrate and combines with the nickel to form an outer surface of the nickel-aluminum alloy. Aluminum oxide layers are typically grown, deposited, or otherwise formed on top of the metal aluminide layers when in a relatively high temperature environment with oxygen.

Corrosion can occur on the aerospace component and continue to expand through different phases. Corrosion can be on or within any of the protective coatings and/or can be on the base metal, such as the nickel superalloy. Typically, an aerospace component containing corrosion is replaced and discarded—such as scrapped, recycled, or buried in a landfill.

Therefore, there is a need for improved methods to refurbish aerospace components, more specifically, improved cleaning and metrology processes used on aerospace components, such as cleaning processes to remove corrosion and oxidation and the end-point detection of such cleaning processes.

### SUMMARY

Embodiments of the present disclosure generally relate to cleaning processes for aerospace components and methods for depositing protective coatings on the aerospace components. In one or more embodiments, a method of refurbishing an aerospace component includes exposing the aerospace component containing corrosion to an aqueous cleaning solution. The aerospace component contains a nickel superalloy, an aluminide layer disposed on the nickel superalloy, and an aluminum oxide layer disposed on the aluminide layer. In one or more embodiments, the corrosion (e.g., Phase 1 corrosion) is contained on a first or upper portion of the aluminum oxide layer while a second or lower portion of the aluminum oxide layer is free of the corrosion. The method also includes removing the corrosion from the first portion of the aluminum oxide layer with the aqueous cleaning solution to reveal the first portion of the aluminum oxide layer, then exposing the first and second portions of the aluminum oxide layer to a post-rinse, and forming a protective coating on the first and second portions of the aluminum oxide layer.

In some embodiments, a method for detecting an end-point of a cleaning process for an aerospace component where the corrosion is contained on the aluminum oxide layer. The method includes analyzing a reference solvent by absorbance spectroscopy (e.g., UV-vis spectroscopy) to determine a reference solute concentration of the reference solvent, exposing the aerospace component to a first solvent, exposing the aerospace component to a first water rinse, and analyzing a first aliquot of the first water rinse by absorbance spectroscopy to determine an intermediate solute concentration in the first aliquot, where the intermediate solute concentration is greater than the reference solute concentration. The method further includes exposing the aerospace component containing corrosion to an aqueous cleaning solution to remove the corrosion from the aluminum oxide layer, exposing the aerospace component to a second solvent, and exposing the aerospace component to a second water rinse, and analyzing a second aliquot of the second water rinse by absorbance spectroscopy to determine a post-clean solute concentration in the second aliquot, where the post-clean solute concentration is less than the intermediate solute concentration.

In other embodiments, a method of refurbishing an aerospace component includes exposing the aerospace component containing corrosion to an acidic cleaning solution containing, for example, sulfuric acid. The aerospace component contains a nickel superalloy, an aluminide layer disposed on the nickel superalloy, and an aluminum oxide layer disposed on the aluminide layer. The corrosion (e.g., Phase 2 corrosion) is contained on and within the aluminum oxide layer. The method also includes removing the corrosion and the aluminum oxide layer with the acidic cleaning solution to reveal the aluminide layer, then exposing the aluminide layer to a post-rinse, and forming a protective coating on the aluminide layer.

In some embodiments, a method of refurbishing an aerospace component includes exposing the aerospace component containing corrosion to an acidic cleaning solution containing, for example, hydrogen fluoride and nitric acid. The aerospace component contains a nickel superalloy, an aluminide layer disposed on the nickel superalloy, and an aluminum oxide layer disposed on the aluminide layer. The corrosion (e.g., Phase 3 corrosion) is contained on the aluminum oxide layer and within the aluminum oxide layer and a first portion of the aluminide layer. The method also includes removing the corrosion, the aluminum oxide layer, and the first portion of the aluminide layer with the acidic cleaning solution to reveal a second portion of the aluminide layer, then exposing the aerospace component to a post-rinse, and forming a protective coating on the second portion of the aluminide layer.

In other embodiments, a method for detecting an end-point of a cleaning process for an aerospace component where the corrosion is contained within at least one of the aluminum oxide layer or the aluminide layer. The method includes analyzing a reference solvent by absorbance spectroscopy to determine a reference solute concentration of the reference solvent, exposing the aerospace component to a first solvent, exposing the aerospace component to a first water rinse, analyzing a first aliquot of the first water rinse by absorbance spectroscopy to determine a first intermediate solute concentration in the first aliquot, where the first intermediate solute concentration is greater than the reference solute concentration. The method further includes exposing the aerospace component to a first aqueous cleaning solution to remove the corrosion from the aluminum oxide layer, exposing the aerospace component to a first sonication in water, exposing the aerospace component to a second water rinse, and analyzing a second aliquot of the second water rinse by absorbance spectroscopy to determine a second intermediate solute concentration in the second aliquot, where the second intermediate solute concentration is less than the first intermediate solute concentration. The method also includes exposing the aerospace component to an acidic cleaning solution to remove the corrosion from the aluminum oxide layer and/or or the aluminide layer, exposing the aerospace component to a second sonication in water, exposing the aerospace component to a third water rinse, and analyzing a third aliquot of the third water rinse by absorbance spectroscopy to determine a third intermediate solute concentration in the third aliquot, where the third intermediate solute concentration is less than the second intermediate solute concentration. The method also includes exposing the aerospace component to a second aqueous cleaning solution to remove the corrosion from the aluminum oxide layer and/or or the aluminide layer, exposing the aerospace component to a second solvent, exposing the aerospace component to a fourth water rinse, and analyzing a fourth aliquot of the fourth water rinse by absorbance spectroscopy to determine a post-clean solute concentration in the fourth aliquot, where the post-clean solute concentration is less than the third intermediate solute concentration.

A refurbished aerospace component is produced or formed by any one of the methods described and discussed herein. Exemplary aerospace components can be or include a turbine blade, a turbine blade root, a turbine disk, a turbine vane, a support member, a frame, a rib, a fin, a pin fin, a fuel nozzle, a fuel line, a fuel valve, a combustor liner, a combustor shield, a heat exchanger, or an internal cooling channel.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIGS. 1A-1C depict schematic views of an aerospace component having corrosion and being treated at different stages or operations of a refurbishing process, according to one or more embodiments described and discussed herein.

FIGS. 2A-2B are flow charts illustrating different stages or operations of the refurbishing process depicted in FIGS. 1A-1C, according to one or more embodiments described and discussed herein.

FIG. 2C is a flow chart illustrating different stages or operations of a method for detecting an end-point of a cleaning process for an aerospace component, according to one or more embodiments described and discussed herein.

FIGS. 3A-3D depict schematic views of an aerospace component having corrosion and being treated at different stages or operations of another refurbishing process, according to one or more embodiments described and discussed herein.

FIGS. 4A-4B are flow charts illustrating different stages or operations of the refurbishing process depicted in FIGS. 3A-3D, according to one or more embodiments described and discussed herein.

FIG. 4C is a flow chart illustrating different stages or operations of another method for detecting an end-point of a cleaning process for an aerospace component, according to one or more embodiments described and discussed herein.

FIGS. 5A-5D depict schematic views of an aerospace component having corrosion and being treated at different stages or operations of another refurbishing process, according to one or more embodiments described and discussed herein.

FIGS. 6A-6B are flow charts illustrating different stages or operations of the refurbishing process depicted in FIGS. 5A-5D, according to one or more embodiments described and discussed herein.

FIG. 6C is a flow chart illustrating different stages or operations of another method for detecting an end-point of a cleaning process for an aerospace component, according to one or more embodiments described and discussed herein.

FIGS. 7A-7B are schematic views of a refurbished aerospace component containing one or more protective coatings, according to one or more embodiments described and discussed herein.

To facilitate understanding, identical reference numerals have been used, where possible, to designate identical elements that are common to the Figures. It is contemplated that elements and features of one or more embodiments may be beneficially incorporated in other embodiments.

### DETAILED DESCRIPTION

Embodiments of the present disclosure generally relate to cleaning processes for aerospace components and methods for depositing protective coatings on the aerospace components. The main body of the aerospace component typically contains nickel, such as a nickel alloy or a nickel superalloy. On the inner and/or outer surfaces of the main body, the aerospace component can have an initial or first protective coating of one or more layers, such as one or more metal aluminide layers disposed on the nickel superalloy and one or more aluminum oxide layers disposed on the metal aluminide layer. In some embodiments, the aerospace component as described and discussed herein can be or include one or more turbine blades, turbine blade roots (e.g., fir tree or dovetail), turbine disks, turbine vanes, internal cooling channels, support members, frames, ribs, fins, pin fins, fuel nozzles, combustor liners, combustor shields, heat exchangers, fuel lines, fuel valves, or any other aerospace component or part that can benefit from having corrosion removed and a protective coating deposited thereon. The initial protective coatings can be deposited or otherwise formed on interior surfaces and/or exterior surfaces of the aerospace components.

Corrosion on the aerospace component occurs in various phases and reaches different depths of the initial protective coating on the aerospace component until the corrosion reaches and damages the underlying aerospace component. In one or more examples, the aerospace component has an initial protective coating which contains an outer layer of aluminum oxide and an inner layer of metal aluminide layer disposed on the nickel superalloy surface of the aerospace component body. Methods described and discussed herein remove corrosion at multiple phases. In Phase 1, the corrosion is contained on a first portion of the aluminum oxide layer while a second portion of the aluminum oxide layer and all of the metal aluminide layer are free of the corrosion. In Phase 2, the corrosion has progressed and includes the corrosion of Phase 1 and also includes corrosion of the second portion of the aluminum oxide layer, while all of the metal aluminide layer is free of the corrosion. In Phase 3, the corrosion has progressed and includes the corrosion of Phases 1 and 2 and also includes corrosion of the metal aluminide layer. In Phases 1-3, the nickel superalloy surface of the aerospace component body remains free of corrosion. In Phase 4, the corrosion has progressed and includes the corrosion of Phases 1-3 and also includes corrosion of the nickel superalloy of the aerospace component body.

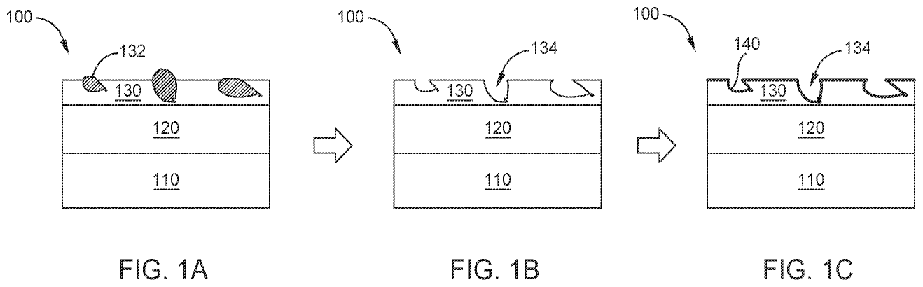

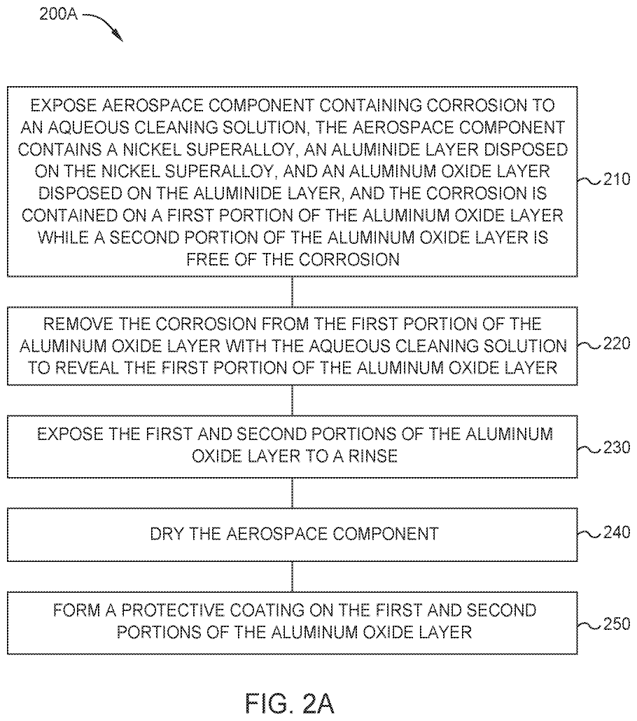

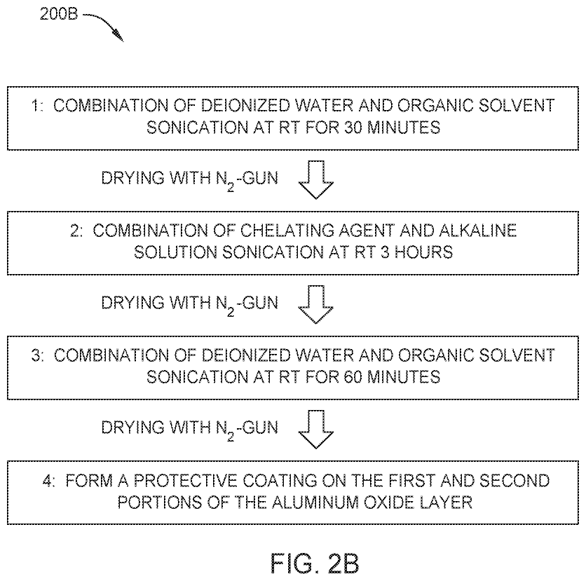

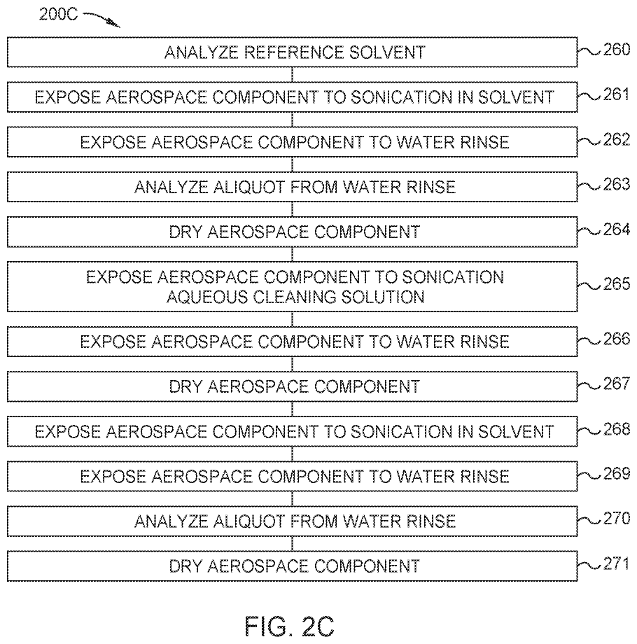

FIGS. 1A-1C depict schematic views of a workpiece 100 containing an aerospace component 110 having corrosion at Phase 1 and being treated at different stages or operations of a refurbishing process. FIG. 2A is a flow chart illustrating a method 200A which includes some of the different stages or operations 210-250 of the refurbishing process of the workpiece 100 depicted in FIGS. 1A-1C.

The workpiece 100 has one or more aluminide layers 120 disposed on the nickel superalloy surface of the aerospace component 110 and one or more aluminum oxide layers 130 disposed on the aluminide layer 120, as depicted in FIG. 1A. Corrosion 132 is contained on a first portion of the aluminum oxide layer 130 while a second portion of the aluminum oxide layer 130 is free of the corrosion 132. For example, the first portion of the aluminum oxide layer 130 contains the corrosion 132 while the second portion of the aluminum oxide layer 130 is substantially or completely free of the corrosion 132. The corrosion 132 is at and on the upper surface of the aluminum oxide layer 130 and extends into the first portion of the aluminum oxide layer 130. The aluminide layer 120 and the superalloy of the aerospace component 110 are both substantially or completely free of the corrosion 132 at Phase 1 of the corrosion.

The aluminide layer 120 contains one or more metal aluminides which can be or include nickel aluminide, titanium aluminide, magnesium aluminide, iron aluminide, or combinations thereof. The aluminide layer 120 has a thickness of about 10 μm, about 20 μm, about 30 μm, about 50 μm, about 80 μm, or about 100 μm to about 120 μm, about 150 μm, about 180 μm, about 200 μm, about 250 μm, about 300 μm, about 400 μm, about 500 μm, about 700 μm, or thicker. For example, the aluminide layer 120 has a thickness of about 10 μm to about 700 μm, about 20 μm to about 700 μm, about 20 μm to about 500 μm, about 20 μm to about 300 μm, about 20 μm to about 200 μm, about 20 μm to about 150 μm, about 20 μm to about 100 μm, about 20 μm to about 50 μm, about 50 μm to about 700 μm, about 50 μm to about 500 μm, about 50 μm to about 300 μm, about 50 μm to about 200 μm, about 50 μm to about 150 μm, about 50 μm to about 100 μm, about 50 μm to about 80 μm, about 100 μm to about 700 μm, about 100 μm to about 500 μm, about 100 μm to about 300 μm, about 100 μm to about 200 μm, about 100 μm to about 150 μm, or about 100 μm to about 120 μm.

The aluminum oxide 130 can include fully oxidized aluminum, such as Al₂O₃ and/or less oxidized aluminum, such as AlOₓ, where x is from about 0.1 to less than 1.5, about 0.5 to about 1.4, about 0.8 to about 1.2, about 0.9 to about 1.1, or about 1. The aluminum oxide 130 has a thickness of about 1 μm, about 2 μm, about 3 μm, about 4 μm, about 5 μm, about 8 μm, or about 10 μm to about 12 μm, about 15 μm, about 20 μm, about 30 μm, about 50 μm, about 80 μm, or about 100 μm. For example, the aluminum oxide 130 has a thickness of about 1 μm to about 100 μm, about 1 μm to about 80 μm, about 1 μm to about 50 μm, about 1 μm to about 30 μm, about 1 μm to about 20 μm, about 1 μm to about 15 μm, about 1 μm to about 10 μm, about 1 μm to about 5 μm, about 5 μm to about 100 μm, about 5 μm to about 80 μm, about 5 μm to about 50 μm, about 5 μm to about 30 μm, about 5 μm to about 20 μm, about 5 μm to about 15 μm, about 5 μm to about 10 μm, about 5 μm to about 8 μm, about 10 μm to about 100 μm, about 10 μm to about 80 μm, about 10 μm to about 50 μm, about 10 μm to about 30 μm, about 10 μm to about 20 μm, about 10 μm to about 15 μm, about 10 μm to about 12 μm, about 2 μm to about 20 μm, about 3 μm to about 10 μm, or about 4 μm to about 8 μm.

In some embodiments, prior to exposing the workpiece 100 containing the aerospace component 110 to the aqueous cleaning solution to remove the corrosion at operation 210, the workpiece 100 can be exposed to a pre-rinse. The pre-rinse contains one or more organic solvents and water. Exemplary organic solvents can be or include acetone, methanol, ethanol, isopropanol, pentane, hexane, diethyl ether, or combinations thereof. The pre-rinse can include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the pre-rinse contains a 1:1 mixture of acetone to deionized water.

The pre-rinse lasts for about 5 minutes to about 60 minutes, about 10 minutes to about 50 minutes, about 15 minutes to about 45 minutes, about 20 minutes to about 40 minutes, or about 30 minutes. The workpiece 100 can be sonicated while in the pre-rinse. The pre-rinse can be heated and/or maintained at a temperature of about 20° C., about 22° C., about 25° C., about 30° C. to about 35° C., about 40° C., about 50° C., about 80° C., or about 100° C. For example, the pre-rinse can be heated and/or maintained at a temperature of about 20° C. to about 100° C., about 20° C. to about 50° C., or about 20° C. to about 30° C., such as at a room temperature of about 22° C. or about 23° C. After the pre-rinse, the workpiece 100 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more embodiments, a method 200A of refurbishing an aerospace component 110 includes exposing the workpiece 100 containing corrosion 132 to an aqueous cleaning solution at operation 210. As depicted in FIG. 1A, the corrosion 132 (e.g., Phase 1 corrosion 132) is contained on the first portion of the aluminum oxide layer 130 while the second portion of the aluminum oxide layer 130 is free of the corrosion 132. At operation 220, the corrosion 132 is removed from the first portion of the aluminum oxide layer 130 with the aqueous cleaning solution to reveal the first portion of the aluminum oxide layer 130, as depicted in FIG. 1B. The first portion of the aluminum oxide layer 130 is typically within one or more voids or spaces 134 formed in the aluminum oxide layer 130 below the upper surface of the aluminum oxide layer 130.

The aqueous cleaning solution contains water, one or more chelators or complexing agents, and one or more bases (e.g., hydroxide). Exemplary chelators or complexing agents can be or include oxalic acid, citric acid, bipyridine, o-phenylenediamine, ethylenediamine (EDA), nitrilotriacetic acid (NTA), iminodiacetic acid, picolinic acid, (1,1,1)-trifluoroacetylacetone, 1,4,7-triazacyclononane (TACN), (N,N,N′,N′-tetrakis(2-pyridinylmethyl)-1,2-ethanediamine (TPEN), ethylenediaminetetraacetic acid (EDTA), ethylenediaminediacetic acid (EDDA), ethylenediamine-N,N′-disuccinic acid (EDDS), ethylenediamine-N,N′-bis(2-hydroxyphenylacetic acid) (EDDHA), 1,4,7,10-tetraazacyclododecane-1,4,7,10-tetraacetic acid (DOTA, 1,2-bis(o-aminophenoxy)ethane-N,N,N′,N′-tetraacetic acid) (BAPTA), aminoethylethanolamine (AEEA), thenoyltrifluoroacetone, salts thereof, adducts thereof, complexes thereof, or any combination thereof. Bases are used to increase the pH of the aqueous cleaning solution and can be or include inorganic bases and/or organic bases. In some examples, one or more hydroxides are used as the base. Exemplary hydroxides can be or include sodium hydroxide, potassium hydroxide, lithium hydroxide, cesium hydroxide, ammonium hydroxide, or any combination thereof. In one or more examples, the complexing agent can be or include EDTA and/or a salt thereof and the base can be or include one or more hydroxides.

At operations 210 and 220, workpiece 100 containing the aerospace component 110 is exposed to the aqueous cleaning solution for about 0.5 hours, about 0.8 hours, about 1 hour, or about 1.5 hours to about 2 hours, about 2.5 hours, about 3 hours, about 4 hours, about 5 hours, or longer. For example, workpiece 100 is exposed to the aqueous cleaning solution for about 0.5 hours to about 5 hours, about 1 hour to about 5 hours, about 2 hours to about 5 hours, about 2.5 hours to about 5 hours, about 3 hours to about 5 hours, about 4 hours to about 5 hours, about 0.5 hours to about 4 hours, about 1 hour to about 4 hours, about 2 hours to about 4 hours, about 2.5 hours to about 4 hours, about 3 hours to about 4 hours, about 0.5 hours to about 3 hours, about 1 hour to about 3 hours, about 2 hours to about 3 hours, or about 2.5 hours to about 3 hours. The workpiece 100 can be sonicated while in the aqueous cleaning solution.

The aqueous cleaning solution can be heated and/or maintained at a temperature of about 20° C., about 22° C., about 25° C., about 30° C. to about 35° C., about 40° C., about 50° C., about 80° C., or about 100° C. For example, the aqueous cleaning solution can be heated and/or maintained at a temperature of about 20° C. to about 100° C., about 20° C. to about 50° C., or about 20° C. to about 30° C., such as at a room temperature of about 22° C. or about 23° C. After operation 220 and before operation 230, the workpiece 100 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more embodiments, subsequent to operation 220, the workpiece 100 including the first and second portions of the aluminum oxide layer 130 can be exposed to a post-rinse at operation 230. The post-rinse contains one or more organic solvents and water. Exemplary organic solvents can be or include acetone, methanol, ethanol, isopropanol, pentane, hexane, diethyl ether, or combinations thereof. The post-rinse can include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the post-rinse contains a 1:1 mixture of acetone to deionized water.

The post-rinse lasts for about 5 minutes to about 60 minutes, about 10 minutes to about 50 minutes, about 15 minutes to about 45 minutes, about 20 minutes to about 40 minutes, or about 30 minutes. The workpiece 100 containing the aerospace component 110 can be sonicated while in the post-rinse. The post-rinse can be heated and/or maintained at a temperature of about 20° C., about 22° C., about 25° C., about 30° C. to about 35° C., about 40° C., about 50° C., about 80° C., or about 100° C. For example, the post-rinse can be heated and/or maintained at a temperature of about 20° C. to about 100° C., about 20° C. to about 50° C., or about 20° C. to about 30° C., such as at a room temperature of about 22° C. or about 23° C.

After the post-rinse, the workpiece 100 can optionally be dried at operation 240. In some examples, the aerospace component 110 can be air dried at ambient temperature and/or pressure in the air. In other examples, the workpiece 100 can be exposed to a flow of air, nitrogen (N₂), argon, or a mixture thereof from a blower, a fan, or the like at an ambient or heated temperature.

At operation 250, a protective coating 140 can be deposited or otherwise formed on the first and second portions of the aluminum oxide layer 130, as depicted in FIG. 1C. The first portion of the aluminum oxide layer 130 is within one or more voids or spaces 134 formed in the aluminum oxide layer 130. The protective coating 140 is deposited or otherwise formed conformally over and on the first and second portions of the aluminum oxide layer 130 including within the voids or spaces 134. In one or more embodiments, the protective coating 140 contains one or more of chromium oxide, aluminum oxide, aluminum nitride, hafnium oxide, titanium oxide, titanium nitride, tantalum oxide, tantalum nitride, dopants thereof, or any combination thereof. In other embodiments, the protective coating 140 can be or include any one or more of the protective coatings, the nanolaminate film stacks, materials, layers, or combinations thereof described and discussed herein. The protective coating 140 has a thickness of about 1 nm to about 10,000 nm, as further described and discussed below.

FIG. 2B is a flow chart illustrating a method 200B, which is an exemplary version of the method 200A with optional operations during a cleaning process and/or a refurbishing process. In one or more examples, the workpiece 100 containing the aerospace component 110 having corrosion at Phase 1 can be treated by the method 200B, which includes: (1) exposing the workpiece 100 to a pre-rinse; optionally drying the workpiece 100; (2) exposing the workpiece 100 including the aluminum oxide layer 130 to an aqueous cleaning solution; optionally drying the workpiece 100; (3) exposing the workpiece 100 including the aluminum oxide layer 130 to a post-rinse; optionally drying the workpiece 100; and (4) forming a protective coating 140 over and on the first and second portions of the aluminum oxide layer 130.

In some examples, the method 200B can include: (1a) exposing the workpiece 100 to a pre-rinse containing a combination of deionized water and one or more organic solvents while sonicating at room temperature (e.g., about 23° C.) for about 30 minutes; (1b) drying the workpiece 100 with nitrogen gas from a nitrogen gun; (2a) exposing the workpiece 100 including the aluminum oxide layer 130 to an aqueous cleaning solution containing a combination of one or more chelating agents and one or more alkaline solutions while sonicating at room temperature (e.g., about 23° C.) for about 3 hours; (2b) drying the workpiece 100 with nitrogen gas from a nitrogen gun; (3a) exposing the workpiece 100 including the aluminum oxide layer 130 to a post-rinse containing a combination of deionized water and one or more organic solvents while sonicating at room temperature (e.g., about 23° C.) for about 60 minutes; (3b) drying the workpiece 100; (4) forming a protective coating 140 conformally over and on the first and second portions of the aluminum oxide layer 130.

FIG. 2C is a flow chart illustrating a method 200C for detecting an end-point of a cleaning process, according to one or more embodiments described and discussed herein. The method 200C, and variations thereof, can be used in conjunction with the method 200A while cleaning workpieces and/or aerospace components during a refurbishing process. In one or more examples, the workpiece 100 containing the aerospace component 110 having corrosion at Phase 1 can be treated by the method 200C. The method 200C for detecting the end-point of the cleaning process provides monitoring and analyzing samples or aliquots of the rinses during the cleaning process. The rinses can be analyzed by ultraviolet-visible (UV-vis) absorbance spectroscopy which can be used on a real-time analysis of the rinse and/or of samples or aliquots of the rinse. In some examples, corrosion, oxidation, and/or other contaminants are contained on or within the aluminum oxide layer 130 of the workpiece 100 containing the aerospace component 110. In some examples, the corrosion, oxidation, and/or other contaminants are contained on a first portion of the aluminum oxide layer 130 while a second portion of the aluminum oxide layer 130 is free of the corrosion, oxidation, and/or other contaminants.

In one or more embodiments, the method 200C, can be used to detect an end-point of a cleaning process by conducting operations 260-271. The method 200C includes analyzing a reference solvent by absorbance spectroscopy to determine a reference solute concentration of the reference solvent (operation 260). The reference solvent contains the same solvent (e.g., water, one or more organic solvents, or any combination thereof) which will be used in the subsequent samples or aliquots to be analyzed by absorbance spectroscopy. In one or more examples, the reference solvent is removed from the solvent source and directly analyzed by absorbance spectroscopy without exposing the solvent to any aerospace components to determine the reference solute concentration. In other examples, the reference solvent is removed from the solvent source, then exposed to a new aerospace component without corrosion similar to the aerospace component being tested (e.g., same part and/or same coatings), and then the reference solvent is analyzed by absorbance spectroscopy (e.g., UV-vis) for the reference solute concentration.

The method 200C also includes exposing the aerospace component containing corrosion to a first solvent (operation 261), exposing the aerospace component to a first water rinse (operation 262), and analyzing a first aliquot of the first water rinse by absorbance spectroscopy to determine an intermediate solute concentration in the first aliquot (operation 263). The intermediate solute concentration is greater than the reference solute concentration. The method 200C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 464).

The method 200C further includes exposing the aerospace component containing corrosion to an aqueous cleaning solution to remove the corrosion from the first portion of the aluminum oxide layer (operation 265), exposing the aerospace component to an optional supplemental water rinse (operation 266), and optionally drying the aerospace component at ambient temperature and/or pressure or by exposure to a gas (e.g., air, nitrogen (N₂), argon, or mixtures thereof), such as exposing to nitrogen gas from a nitrogen gun (operation 267).

The method 200C includes exposing the aerospace component to a second solvent (operation 268), exposing the aerospace component to a second water rinse (operation 269), and analyzing a second aliquot of the second water rinse by absorbance spectroscopy to determine a post-clean solute concentration in the second aliquot (operation 270). The post-clean solute concentration is less than the intermediate solute concentration. The method 200C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 271).

The aqueous cleaning solution contains water, one or more complexing agents, and one or more bases. In some examples, the complexing agent contains EDTA and/or a salt thereof, and the base contains one or more hydroxides. In other examples, the method further includes exposing the aerospace component to the aqueous cleaning solution for about 1 hour to about 5 hours, sonicating the aerospace component in the aqueous cleaning solution, and maintaining the aqueous cleaning solution at a temperature of about 20° C. to about 50° C.

In other embodiments, the method 200C includes exposing the aerospace component to the first solvent and/or the second solvent for about 5 minutes to about 60 minutes, about 10 minutes to about 45 minutes, or about 20 minutes to about 30 minutes, while sonicating the aerospace component in the first solvent and/or the second solvent, and maintaining the first solvent and/or the second solvent at a temperature of about 20° C. to about 50° C. The first solvent and/or the second solvent can be an aqueous solvent solution, an organic solvent solution, or a mixture thereof. In one or more examples, the first solvent and/or the second solvent independently contains one or more organic solvents. In other examples, the first solvent and/or the second solvent independently contains water (e.g., deionized water) and one or more organic solvents. Exemplary organic solvents can be or include acetone, methanol, ethanol, isopropanol, pentane, hexane, diethyl ether, or combinations thereof. The first solvent and/or the second solvent independently include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the first solvent and/or the second solvent independently contains a 1:1 mixture of acetone to deionized water.

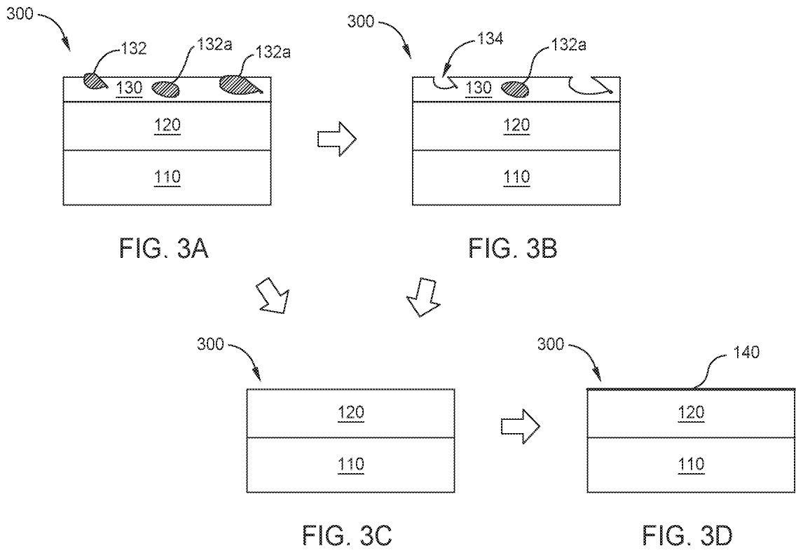

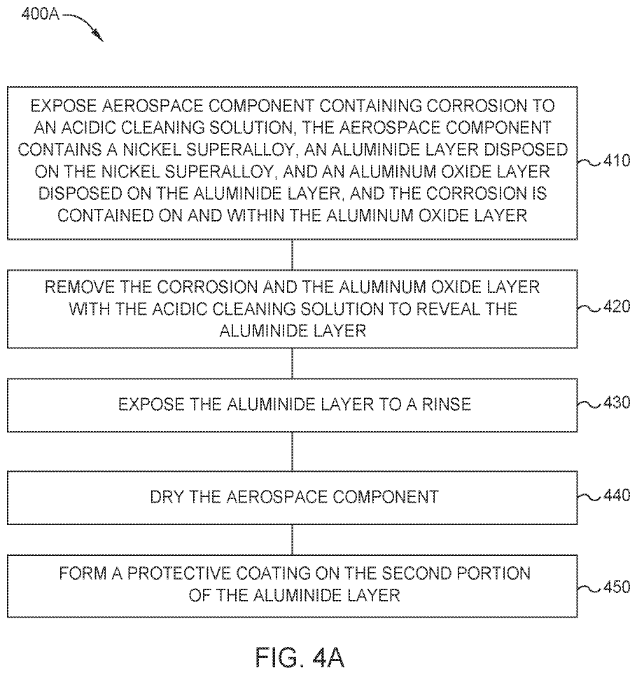

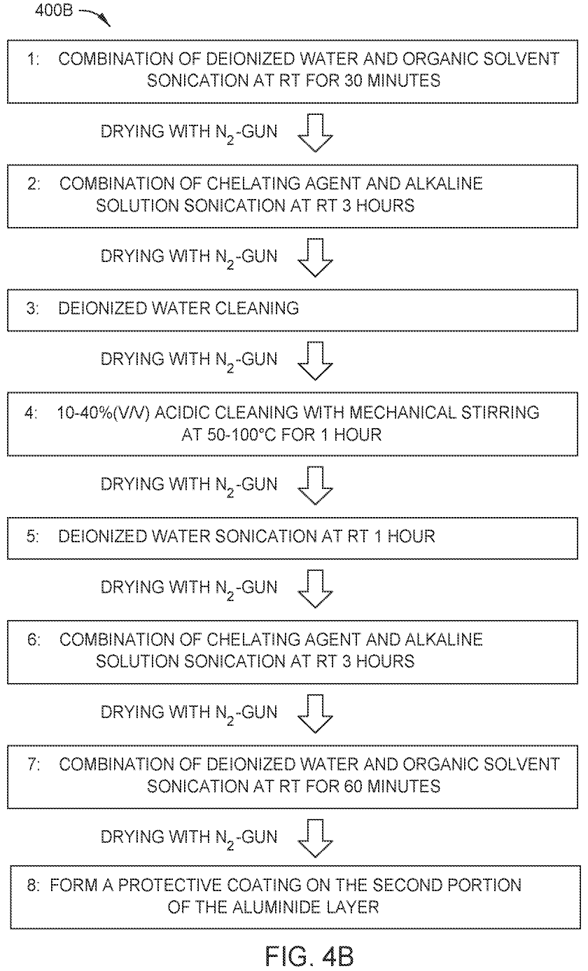

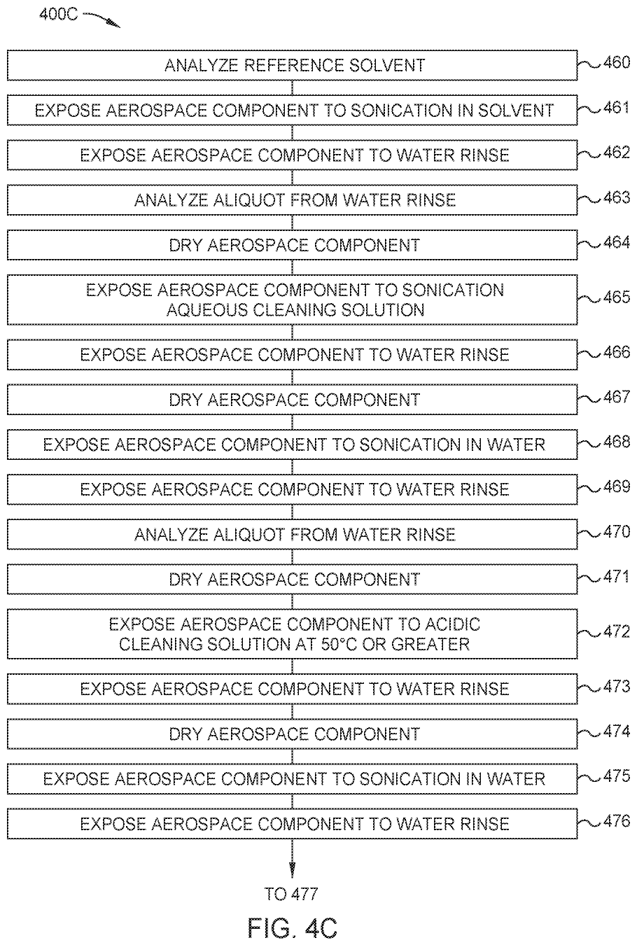

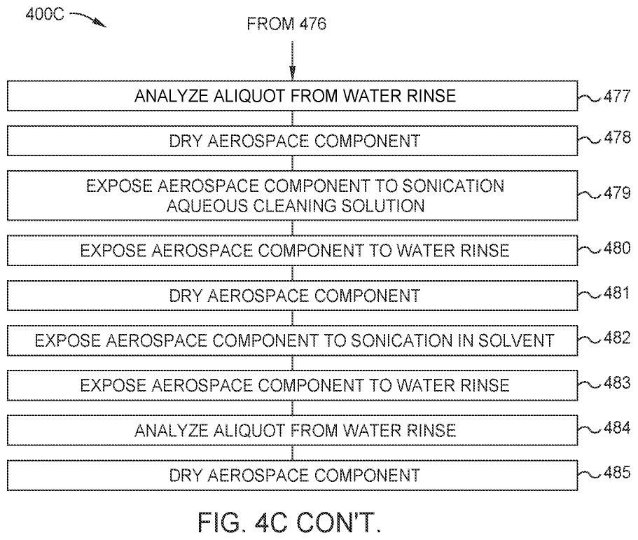

FIGS. 3A-3D depict schematic views of a workpiece 300 containing an aerospace component 110 having corrosion at Phase 2 and being treated at different stages or operations of another refurbishing process. FIG. 4A is a flow chart illustrating a method 400A which includes some of the different stages or operations of the refurbishing process of the workpiece 300 depicted in FIGS. 3A-3D.

The workpiece 300 has one or more aluminide layers 120 disposed on the nickel superalloy surface of the aerospace component 110 and one or more aluminum oxide layers 130 disposed on the aluminide layer 120, as depicted in FIG. 3A. Corrosion 132 is contained in an upper portion of the aluminum oxide layer 130 and in a lower portion of the aluminum oxide layer 130. In the lower portion of the aluminum oxide layer 130, some of the corrosion, depicted as corrosion 132a, is below the upper surface of the aluminum oxide layer 130, such that the corrosion 132a is not visible from a top view of the workpiece 300. The aluminide layer 120 and the superalloy of the aerospace component 110 are both substantially or completely free of the corrosion 132 at Phase 2 of the corrosion.

In some embodiments, prior to exposing the workpiece 300 containing the aerospace component 110 to the acidic cleaning solution to remove the corrosion at operation 410, the workpiece 300 can be exposed one or more processes and/or solutions. The workpiece 300 can be exposed to a pre-rinse, an aqueous cleaning solution, and one or more additional rinses.

The pre-rinse contains one or more organic solvents and water. Exemplary organic solvents can be or include acetone, methanol, ethanol, isopropanol, pentane, hexane, diethyl ether, or combinations thereof. The pre-rinse can include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the pre-rinse contains a 1:1 mixture of acetone to deionized water.

The pre-rinse lasts for about 5 minutes to about 60 minutes, about 10 minutes to about 50 minutes, about 15 minutes to about 45 minutes, about 20 minutes to about 40 minutes, or about 30 minutes. The workpiece 300 can be sonicated while in the pre-rinse. The pre-rinse can be heated and/or maintained at a temperature of about 20° C., about 22° C., about 25° C., about 30° C. to about 35° C., about 40° C., about 50° C., about 80° C., or about 100° C. For example, the pre-rinse can be heated and/or maintained at a temperature of about 20° C. to about 100° C., about 20° C. to about 50° C., or about 20° C. to about 30° C., such as at a room temperature of about 22° C. or about 23° C. After the pre-rinse, the workpiece 300 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more embodiments, prior to operation 410, the workpiece 300 containing the aerospace component 110 can be exposed to the aqueous cleaning solution. The solutions and process conditions described for the aqueous cleaning solution in operations 210 and 220 can be used with the workpiece 300 prior to operation 410.

As depicted in FIG. 3A, the corrosion 132 (e.g., Phase 2 corrosion 132) is contained on the first portion of the aluminum oxide layer 130 while the second portion of the aluminum oxide layer 130 also contains the corrosion 132a below the upper surface of the aluminum oxide layer 130. The aqueous cleaning solution removes the corrosion 132 from the first portion of the aluminum oxide layer 130 to reveal the first portion of the aluminum oxide layer 130, but fails to remove the corrosion 132a from below the upper surface of the aluminum oxide layer 130, as depicted in FIG. 3B. The first portion of the aluminum oxide layer 130 is typically within one or more voids or spaces 134 formed in the aluminum oxide layer 130 below the upper surface of the aluminum oxide layer 130.

The aqueous cleaning solution contains water, one or more chelators or complexing agents, and one or more bases (e.g., hydroxide). Exemplary chelators or complexing agents can be or include oxalic acid, citric acid, bipyridine, o-phenylenediamine, ethylenediamine (EDA), nitrilotriacetic acid (NTA), iminodiacetic acid, picolinic acid, (1,1,1)-trifluoroacetylacetone, 1,4,7-triazacyclononane (TACN), (N,N,N′,N′-tetrakis(2-pyridinylmethyl)-1,2-ethanediamine (TPEN), ethylenediaminetetraacetic acid (EDTA), ethylenediaminediacetic acid (EDDA), ethylenediamine-N,N′-disuccinic acid (EDDS), ethylenediamine-N,N′-bis(2-hydroxyphenylacetic acid) (EDDHA), 1,4,7,10-tetraazacyclododecane-1,4,7,10-tetraacetic acid (DOTA, 1,2-bis(o-aminophenoxy)ethane-N,N,N′,N′-tetraacetic acid) (BAPTA), aminoethylethanolamine (AEEA), thenoyltrifluoroacetone, salts thereof, adducts thereof, complexes thereof, or any combination thereof. Bases are used to increase the pH of the aqueous cleaning solution and can be or include inorganic bases and/or organic bases. In some examples, one or more hydroxides are used as the base. Exemplary hydroxides can be or include sodium hydroxide, potassium hydroxide, lithium hydroxide, cesium hydroxide, ammonium hydroxide, or any combination thereof. In one or more examples, the complexing agent can be or include EDTA and/or a salt thereof and the base can be or include one or more hydroxides.

In one or more examples, workpiece 300 containing the aerospace component 110 is exposed to the aqueous cleaning solution for about 0.5 hours, about 0.8 hours, about 1 hour, or about 1.5 hours to about 2 hours, about 2.5 hours, about 3 hours, about 4 hours, about 5 hours, or longer. For example, workpiece 300 is exposed to the aqueous cleaning solution for about 0.5 hours to about 5 hours, about 1 hour to about 5 hours, about 2 hours to about 5 hours, about 2.5 hours to about 5 hours, about 3 hours to about 5 hours, about 4 hours to about 5 hours, about 0.5 hours to about 4 hours, about 1 hour to about 4 hours, about 2 hours to about 4 hours, about 2.5 hours to about 4 hours, about 3 hours to about 4 hours, about 0.5 hours to about 3 hours, about 1 hour to about 3 hours, about 2 hours to about 3 hours, or about 2.5 hours to about 3 hours. The workpiece 300 can be sonicated while in the aqueous cleaning solution.

The aqueous cleaning solution can be heated and/or maintained at a temperature of about 20° C., about 22° C., about 25° C., about 30° C. to about 35° C., about 40° C., about 50° C., about 80° C., or about 100° C. For example, the aqueous cleaning solution can be heated and/or maintained at a temperature of about 20° C. to about 100° C., about 20° C. to about 50° C., or about 20° C. to about 30° C., such as at a room temperature of about 22° C. or about 23° C. After operation 420 and before operation 430, the workpiece 300 can optionally be dried, such as air dried at ambient temperature and/or pressure in the air or exposed to a flow of air, nitrogen (N₂), argon, or a mixture thereof from a blower, a fan, or the like at an ambient or heated temperature.

In some examples, after the exposure of the aqueous cleaning solution, the workpiece 300 can be exposed to the rinse, such as with deionized water, one or more organic solvents, or a combination thereof. The workpiece 300 can be exposed to the rinse for about 5 minutes to about 60 minutes, about 10 minutes to about 50 minutes, about 15 minutes to about 45 minutes, about 20 minutes to about 40 minutes, or about 30 minutes. The workpiece 300 can optionally be sonicated while being rinsed. After the rinse, the workpiece 300 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more examples, prior to exposing the workpiece 300 to the acidic cleaning solution, the workpiece 300 is exposed to a pre-rinse for about 5 minutes to about 60 minutes, about 10 minutes to about 45 minutes, or about 20 minutes to about 30 minutes, and the workpiece 300 is sonicated in the pre-rinse, which contains one or more organic solvents and water and is maintained at a temperature of about 20° C. to about 50° C. In other examples, prior to exposing the workpiece 300 to the acidic cleaning solution, the workpiece 300 is exposed to an aqueous cleaning solution for about 1 hour to about 5 hours, the aerospace component 110 is sonicated in the aqueous cleaning solution, which contains water, one or more complexing agents, and one or more bases and is maintained at a temperature of about 20° C. to about 50° C.

In one or more embodiments, the method 400A of refurbishing an aerospace component 110 includes exposing the workpiece 300 containing corrosion 132 and/or 132a to an acidic cleaning solution at operation 410. At operation 420, the aluminum oxide layer 130 and any corrosion 132 and/or 132a are removed from the workpiece 300 by the acidic cleaning solution to reveal on the aluminide layer 120, as depicted in FIG. 3C.

The acidic cleaning solution contains one or more acids, such as sulfuric acid, sulfurous acid, nitric acid, nitrous acid, hydrochloric acid (e.g., hydrogen chloride), perchloric acid, hydrofluoric acid (e.g., hydrogen fluoride), phosphoric acid, citric acid, acetic acid, methanoic acid (formic acid), salts thereof, adducts thereof, complexes thereof, or any combination thereof. The acidic cleaning solution contains water and about 5 volume percent (vol %), about 8 vol %, about 10 vol %, about 12 vol %, about 15 vol %, about 18 vol %, or about 20 vol % to about 22 vol %, about 25 vol %, about 30 vol %, about 35 vol %, about 40 vol %, or about 50 vol % of one or more acids. For example, the acidic cleaning solution contains about 5 vol % to about 50 vol %, about 5 vol % to about 40 vol %, about 10 vol % to about 40 vol %, about 15 vol % to about 40 vol %, about 20 vol % to about 40 vol %, about 25 vol % to about 40 vol %, about 30 vol % to about 40 vol %, about 5 vol % to about 30 vol %, about 10 vol % to about 30 vol %, about 15 vol % to about 30 vol %, about 20 vol % to about 30 vol %, about 25 vol % to about 30 vol %, about 28 vol % to about 30 vol %, about 5 vol % to about 20 vol %, about 10 vol % to about 20 vol %, about 15 vol % to about 20 vol %, about 18 vol % to about 20 vol %. In one or more examples, the acidic cleaning solution contains water and about 10 vol % to about 40 vol % of sulfuric acid.

At operations 410 and 420, workpiece 300 containing the aerospace component 110 is exposed to the acidic cleaning solution for about 10 minutes, about 20 minutes, about 30 minutes, about 40 minutes, about 45 minutes, or about 60 minutes to about 70 minutes, about 75 minutes, about 80 minutes, about 90 minutes, about 2 hours, about 2.5 hours, about 3 hours, or about 4 hours. For example, workpiece 300 is exposed to the acidic cleaning solution for about 10 minutes to about 4 hours, about 10 minutes to about 3 hours, about 10 minutes to about 2 hours, about 10 minutes to about 90 minutes, about 10 minutes to about 60 minutes, about 10 minutes to about 45 minutes, about 10 minutes to about 30 minutes, about 10 minutes to about 20 minutes, about 30 minutes to about 4 hours, about 30 minutes to about 3 hours, about 30 minutes to about 2 hours, about 30 minutes to about 90 minutes, about 30 minutes to about 60 minutes, about 30 minutes to about 45 minutes, about 45 minutes to about 4 hours, about 45 minutes to about 3 hours, about 45 minutes to about 2 hours, about 45 minutes to about 90 minutes, or about 45 minutes to about 60 minutes. The workpiece 300 can be mechanically stirred or sonicated while being exposed to the acidic cleaning solution.

The acidic cleaning solution can be heated and/or maintained at a temperature of about 20° C., about 22° C., about 25° C., about 35° C., about 50° C., or about 70° C. to about 80° C., about 90° C., about 100° C., about 120° C., about 150° C., or about 200° C. during operations 410 and 420. For example, the acidic cleaning solution can be heated and/or maintained at a temperature of about 20° C. to about 200° C., about 50° C. to about 150° C., about 70° C. to about 100° C., about 80° C. to about 90° C., about 70° C. to about 75° C., or about 80° C. to about 85° C. during operations 410 and 420. In one or more examples, the aerospace component 110 is exposed to the acidic cleaning solution for about 30 minutes to about 90 minutes or about 45 minutes to about 75 minutes while the acidic cleaning solution is being stirred and maintained at a temperature of about 50° C. to about 150° C., about 70° C. to about 100° C., or about 80° C. to about 85° C.

After operation 420 and before operation 430, the workpiece 300 can optionally be dried, such as air dried at ambient temperature and/or pressure in the air or exposed to a flow of air, nitrogen (N₂), argon, or a mixture thereof from a blower, a fan, or the like at an ambient or heated temperature.

In some examples, after the exposure of the acidic cleaning solution, the workpiece 300 can be exposed to the rinse, such as with deionized water, one or more organic solvents, or a combination thereof. The workpiece 300 can be exposed to the rinse for about 5 minutes to about 60 minutes, about 10 minutes to about 50 minutes, about 15 minutes to about 45 minutes, about 20 minutes to about 40 minutes, or about 30 minutes. The workpiece 300 can optionally be sonicated while being rinsed. After the rinse, the workpiece 300 can optionally be dried, such as air dried at ambient temperature and/or pressure in the air or exposed to a flow of air, nitrogen (N₂), argon, or a mixture thereof from a blower, a fan, or the like at an ambient or heated temperature.

Subsequently, the workpiece 300 containing the aerospace component 110 can be exposed to an aqueous cleaning solution and a drying process as described and discussed herein. In one or more examples, subsequent to exposing the workpiece 300 to the acidic cleaning solution, the workpiece 300 is exposed to a pre-rinse for about 5 minutes to about 60 minutes, about 10 minutes to about 45 minutes, or about 20 minutes to about 30 minutes, and the workpiece 300 is sonicated in the pre-rinse, which contains one or more organic solvents and water and is maintained at a temperature of about 20° C. to about 50° C. In other examples, subsequent to exposing the workpiece 300 to the acidic cleaning solution, the workpiece 300 is exposed to an aqueous cleaning solution for about 1 hour to about 5 hours, and the aerospace component 110 is sonicated in the aqueous cleaning solution, which contains water, one or more complexing agents, and one or more bases and is maintained at a temperature of about 20° C. to about 50° C.

At operation 430, the workpiece 300 can be exposed to a post-rinse which contains one or more organic solvents and water. Exemplary organic solvents can be or include acetone, methanol, ethanol, isopropanol, pentane, hexane, diethyl ether, or combinations thereof. The post-rinse can include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the post-rinse contains a 1:1 mixture of acetone to deionized water.

The post-rinse lasts for about 5 minutes to about 3 hours, about 20 minutes to about 2 hours, about 30 minutes to about 90 minutes, about 45 minutes to about 75 minutes, such as about 60 minutes. The workpiece 300 can be sonicated while in the post-rinse. The post-rinse can be heated and/or maintained at a temperature of about 20° C., about 22° C., about 25° C., about 30° C. to about 35° C., about 40° C., about 50° C., about 80° C., or about 100° C. For example, the post-rinse can be heated and/or maintained at a temperature of about 20° C. to about 100° C., about 20° C. to about 50° C., or about 20° C. to about 30° C., such as at a room temperature of about 22° C. or about 23° C.

At operation 430, the workpiece 300 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more examples, the aluminide layer 120 is exposed to the post-rinse for about 10 minutes to about 90 minutes, and the workpiece 300 is sonicated in the post-rinse, which contains one or more organic solvents and water and is maintained at a temperature of about 20° C. to about 50° C.

At operation 450, a protective coating 140 can be deposited or otherwise formed on the workpiece 300, such as on the aluminide layer 120, as depicted in FIG. 3D. The protective coating 140 is deposited or otherwise formed conformally over and on the aluminide layer 120. In one or more embodiments, the protective coating 140 contains one or more of chromium oxide, aluminum oxide, aluminum nitride, hafnium oxide, titanium oxide, titanium nitride, tantalum oxide, tantalum nitride, dopants thereof, or any combination thereof. In other embodiments, the protective coating 140 can be or include any one or more of the protective coatings, the nanolaminate film stacks, materials, layers, or combinations thereof described and discussed herein. The protective coating 140 has a thickness of about 1 nm to about 10,000 nm, as further described and discussed below.

FIG. 4B is a flow chart illustrating a method 400B, which is an exemplary version of the method 400A with optional operations during the refurbishing process. In one or more examples, the workpiece 300 containing the aerospace component 110 having corrosion at Phase 2 can be treated by the method 400B, which includes: (1) exposing the workpiece 300 to a pre-rinse; optionally drying the workpiece 300; (2) optionally exposing the workpiece 300 including the aluminum oxide layer 130 to an aqueous cleaning solution; optionally drying the workpiece 300; (3) optionally exposing the workpiece 300 including the aluminum oxide layer 130 to another rinse (e.g., water or mixture of water and organic solvent similar to pre-rinse or post rinse); optionally drying the workpiece 300; (4) exposing the workpiece 300 including the aluminum oxide layer 130 to an acidic cleaning solution containing sulfuric acid; optionally drying the workpiece 300; (5) optionally exposing the workpiece 300 including the aluminum oxide layer 130 to another rinse (e.g., water or mixture of water and organic solvent similar to pre-rinse or post rinse); optionally drying the workpiece 300; (6) optionally exposing the workpiece 300 to an aqueous cleaning solution; optionally drying the workpiece 300; (7) exposing the workpiece 300 including the aluminum oxide layer 130 to a post-rinse; optionally drying the workpiece 300; and (8) forming the protective coating 140 over and on at least a portion (e.g., second portion) of the aluminide layer 120.

In some examples, the method 400B can include: (1a) exposing the workpiece 300 to a pre-rinse containing a combination of deionized water and one or more organic solvents while sonicating at room temperature (e.g., about 23° C.) for about 30 minutes; (1b) drying the workpiece 300 with nitrogen gas from a nitrogen gun; (2a) optionally exposing the workpiece 300 including the aluminum oxide layer 130 to an aqueous cleaning solution containing a combination of one or more chelating agents and one or more alkaline solutions while sonicating at room temperature (e.g., about 23° C.) for about 3 hours; (2b) drying the workpiece 300 with nitrogen gas from a nitrogen gun; (3a) exposing the workpiece 300 including the aluminum oxide layer 130 to a rinse containing deionized water while sonicating for about 1 hour; (3b) drying the workpiece 300 with nitrogen gas from a nitrogen gun; (4a) exposing the workpiece 300 including the aluminum oxide layer 130 to an acidic cleaning solution containing sulfuric acid (about 10 v/v % to about 40 v/v %) while mechanically stirring at a temperature of about 50° C. to about 100° C. for about 1 hour; (4b) drying the workpiece 300 with nitrogen gas from a nitrogen gun; (5a) exposing the workpiece 300 including the aluminum oxide layer 130 to a rinse containing deionized water while sonicating for about 1 hour; (5b) drying the workpiece 300 with nitrogen gas from a nitrogen gun; (6a) exposing the workpiece 300 to an aqueous cleaning solution containing a combination of one or more chelating agents and one or more alkaline solutions while sonicating at room temperature (e.g., about 23° C.) for about 3 hours; drying the workpiece 300 with nitrogen gas from a nitrogen gun; (7a) exposing the workpiece 300 including the aluminum oxide layer 130 to a post-rinse containing a combination of deionized water and one or more organic solvents while sonicating at room temperature (e.g., about 23° C.) for about 60 minutes; (7b) drying the workpiece 300 with nitrogen gas from a nitrogen gun; and (8) forming the protective coating 140 over and on a second portion of the aluminide layer 120.

FIG. 4C is a flow chart illustrating a method 400C for detecting an end-point of a cleaning process, according to one or more embodiments described and discussed herein. The method 400C, and variations thereof, can be used in conjunction with the method 400A while cleaning workpieces and/or aerospace components during a refurbishing process. In one or more examples, the workpiece 300 containing the aerospace component 110 having corrosion at Phase 2 can be treated by the method 400C. Embodiments of the method 400C can be used to detect the end-point of the cleaning process, in part, by monitoring and analyzing samples or aliquots of the rinses during the cleaning processes. The rinses can be analyzed by UV-vis absorbance spectroscopy which can be used on a real-time analysis of the rinse and/or of samples or aliquots of the rinse. In some examples, corrosion, oxidation, and/or other contaminants are contained on or within at least one of the aluminum oxide layer 130 or the aluminide layer 120 of the workpiece 300 containing the aerospace component 110.

In one or more embodiments, the method 400C, can be used to detect an end-point of a cleaning process by conducting operations 460-485. The method 400C includes analyzing a reference solvent by absorbance spectroscopy to determine a reference solute concentration of the reference solvent (operation 460). The reference solvent contains the same solvent (e.g., water, one or more organic solvents, or any combination thereof) which will be used in the subsequent samples or aliquots to be analyzed by absorbance spectroscopy. In one or more examples, the reference solvent is removed from the solvent source and directly analyzed by absorbance spectroscopy without exposing the solvent to any aerospace components to determine the reference solute concentration. In other examples, the reference solvent is removed from the solvent source, then exposed to a new aerospace component without corrosion similar to the aerospace component being tested (e.g., same part and/or same coatings), and then the reference solvent is analyzed by absorbance spectroscopy (e.g., UV-vis) for the reference solute concentration.

The method 400C further includes exposing the aerospace component with corrosion to sonication in a first solvent (operation 461), exposing the aerospace component to a first water rinse (operation 462), and analyzing a first aliquot of the first water rinse by absorbance spectroscopy to determine a first intermediate solute concentration in the first aliquot (operation 463). The first intermediate solute concentration can be greater than the reference solute concentration. The method 400C further includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 464).

The method 400C also includes exposing the aerospace component to a first aqueous cleaning solution to remove the corrosion from the aluminum oxide layer (operation 465), then exposing the aerospace component to an optional supplemental water rinse (operation 466), and optionally drying the aerospace component at ambient temperature and/or pressure or by exposure to a gas (e.g., air, nitrogen (N₂), argon, or mixtures thereof), such as exposing to nitrogen gas from a nitrogen gun (operation 467).

The method 400C further includes exposing the aerospace component to a first sonication in water (operation 468), exposing the aerospace component to a second water rinse (operation 469), and analyzing a second aliquot of the second water rinse by absorbance spectroscopy to determine a second intermediate solute concentration in the second aliquot (operation 470). The second intermediate solute concentration can be less than the first intermediate solute concentration. The method 400C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 471).

The method 400C also includes exposing the aerospace component to an acidic cleaning solution to remove the corrosion from the aluminum oxide layer and/or or the aluminide layer (operation 472), and then exposing the aerospace component to an optional supplemental water rinse (operation 473). In one or more embodiments, the method 400C includes exposing the aerospace component to the acidic cleaning solution for about 20 minutes to about 120 minutes, about 30 minutes to about 90 minutes, or about 45 minutes to about 75 minutes, stirring (e.g., mechanically stirring) or otherwise agitating the acidic cleaning solution while exposing the aerospace component, and maintaining the acidic cleaning solution at a temperature of about 50° C. or greater, such as about 50° C. to about 150° C., about 80° C. to about 120° C., or about 90° C. to about 110° C. In one or more examples, the acidic cleaning solution contains water and about 10 volume percent (vol %) to about 40 vol % of sulfuric acid. The method 400C further includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 474).

The method 400C further includes exposing the aerospace component to a second sonication in water (operation 475), exposing the aerospace component to a third water rinse (operation 476), and analyzing a third aliquot of the third water rinse by absorbance spectroscopy to determine a third intermediate solute concentration in the third aliquot (operation 477). The third intermediate solute concentration can be less than the second intermediate solute concentration. The method 400C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 478).

The method 400C further includes exposing the aerospace component to a second aqueous cleaning solution to remove the corrosion from the aluminum oxide layer and/or or the aluminide layer (operation 479) and exposing the aerospace component to an optional supplemental water rinse (operation 480). The method 400C also includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 481).

The method 400C further includes exposing the aerospace component to a second solvent (operation 482), exposing the aerospace component to a fourth water rinse (operation 483), and analyzing a fourth aliquot of the fourth water rinse by absorbance spectroscopy to determine a post-clean solute concentration in the fourth aliquot (operation 484). The post-clean solute concentration can be less than the third intermediate solute concentration. Each of the first aliquot, the second aliquot, the third aliquot, and the fourth aliquot is independently analyzed by one or more absorbance spectroscopies, such as UV-vis absorbance spectroscopy. The method 400C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 485).

In other embodiments, the method 400C includes exposing the aerospace component to the first solvent and/or the second solvent for about 5 minutes to about 60 minutes, about 10 minutes to about 45 minutes, or about 20 minutes to about 30 minutes, while sonicating the aerospace component in the first solvent and/or the second solvent, and maintaining the first solvent and/or the second solvent at a temperature of about 20° C. to about 50° C. or about 22° C. to about 25° C. The first solvent and/or the second solvent can be an aqueous solvent solution, an organic solvent solution, or a mixture thereof. In one or more examples, the first solvent and/or the second solvent independently contains one or more organic solvents. In other examples, the first solvent and/or the second solvent independently contains water (e.g., deionized water) and one or more organic solvents. Exemplary organic solvents can be or include acetone, methanol, ethanol, isopropanol, pentane, hexane, diethyl ether, or combinations thereof. The first solvent and/or the second solvent independently include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the first solvent and/or the second solvent independently contains a 1:1 mixture of acetone to deionized water.

In some embodiments, the method 400C includes exposing the aerospace component to deionized water for about 5 minutes to about 60 minutes, about 10 minutes to about 45 minutes, or about 20 minutes to about 30 minutes, while sonicating the aerospace component in the deionized water, and maintaining the deionized water at a temperature of about 20° C. to about 50° C. or about 22° C. to about 25° C.

Each of the first aqueous cleaning solution and/or the second aqueous cleaning solution independently contains water, one or more complexing agents, and one or more bases. In some examples, the complexing agent contains EDTA and/or a salt thereof, and the base contains one or more hydroxides. The method 400C further includes exposing the aerospace component to the first and/or second aqueous cleaning solution for about 1 hour to about 5 hours, sonicating the aerospace component in the first and/or second aqueous cleaning solution, and maintaining the first and/or second aqueous cleaning solution at a temperature of about 20° C. to about 50° C. or about 22° C. to about 25° C.

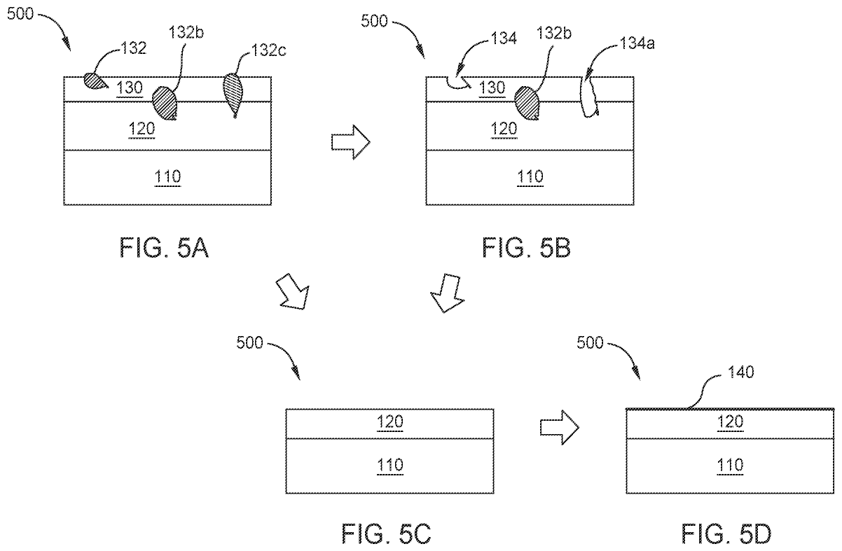

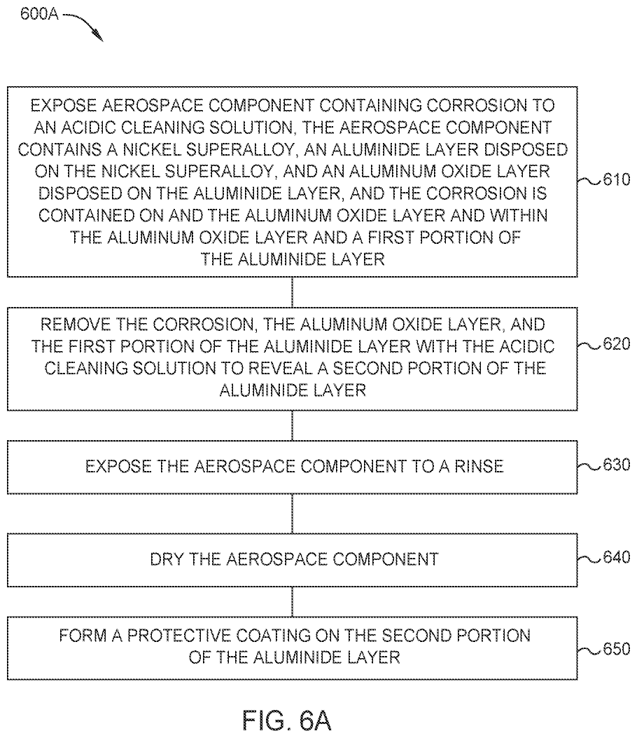

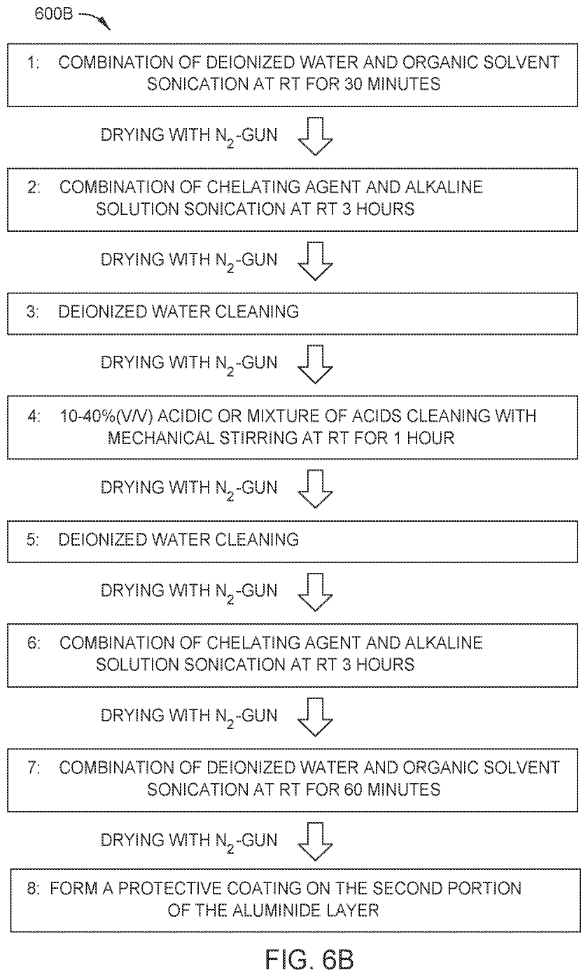

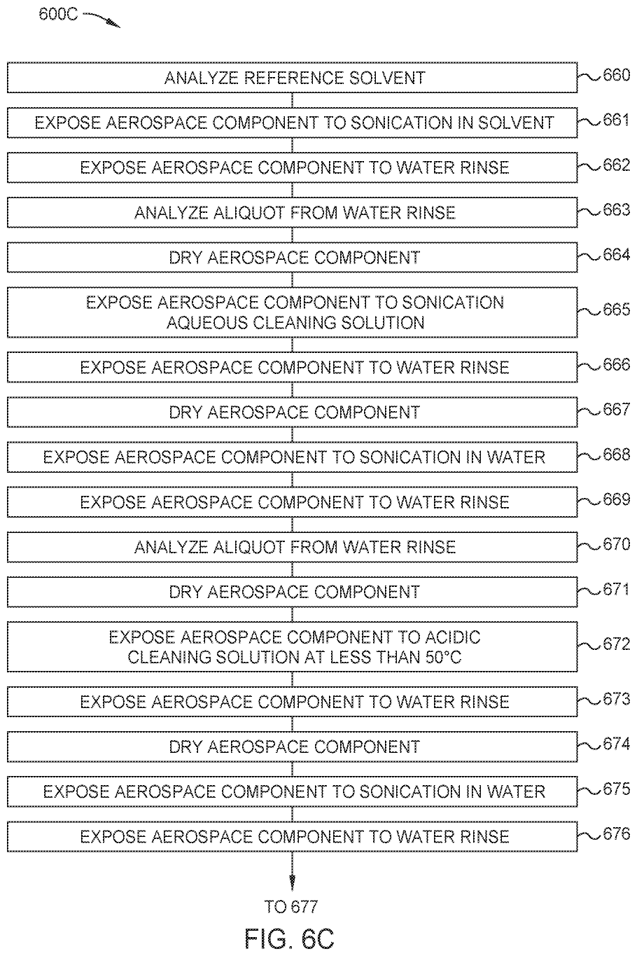

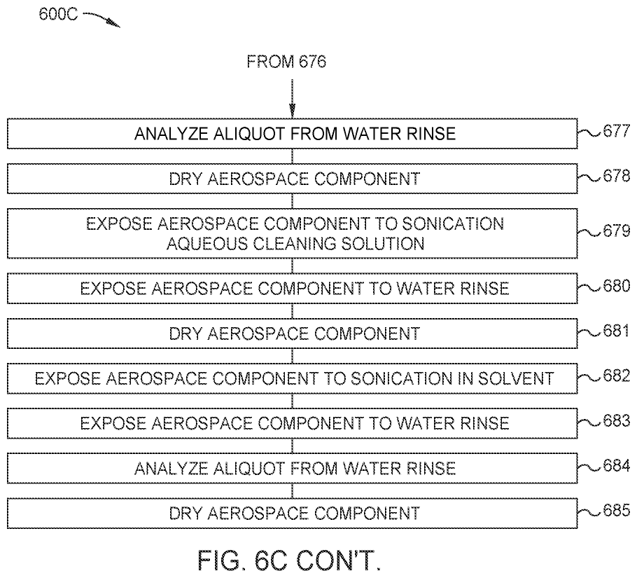

FIGS. 5A-5D depict schematic views of a workpiece 500 containing an aerospace component 110 having corrosion at Phase 3 and being treated at different stages or operations of another refurbishing process. FIG. 6A is a flow chart illustrating a method 600A which includes some of the different stages or operations of the refurbishing process of the workpiece 500 depicted in FIGS. 5A-5D.

The method 600A of refurbishing an aerospace component 110 includes exposing the workpiece 500 containing the aerospace component 110 having corrosion 132 to an acidic cleaning solution at operation 610. The aerospace component 110 contains a nickel superalloy, an aluminide layer 120 disposed on the nickel superalloy, and an aluminum oxide layer 130 disposed on the aluminide layer 120. The corrosion 132 (e.g., Phase 3 corrosion 132) is contained on the aluminum oxide layer 130 and within the aluminum oxide layer 130, as depicted in FIG. 5A. In the lower portion of the aluminum oxide layer 130, some of the corrosion, depicted as corrosion 132b, is below the upper surface of the aluminum oxide layer 130 and can extend into the first or upper portion of the aluminide layer 120, such that the corrosion 132b is not visible from a top view of the workpiece 500. Some of the corrosion, depicted as corrosion 132c, extends from the upper surface of the aluminum oxide layer 130, completely through the aluminum oxide layer 130, and into a first or upper portion of the aluminide layer 120. The superalloy of the aerospace component 110 is substantially or completely free of the corrosion 132 at Phase 3 of the corrosion.

The method 600A includes removing the corrosion 132, the aluminum oxide layer 130, and the first portion of the aluminide layer 120 with the acidic cleaning solution to reveal a second portion of the aluminide layer 120 at operation 620, then exposing the workpiece 500 to a post-rinse at operation 630, exposing the workpiece 500 to a drying process at operation 640, and forming a protective coating 140 on the second portion of the aluminide layer 120 at operation 650.

In some embodiments, prior to exposing the workpiece 500 containing the aerospace component 110 to the acidic cleaning solution to remove the corrosion at operation 610, the workpiece 500 can be exposed one or more processes and/or solutions. The workpiece 500 can be exposed to a pre-rinse, an aqueous cleaning solution, and one or more additional rinses.

The pre-rinse contains one or more organic solvents and water. Exemplary organic solvents can be or include acetone, methanol, ethanol, isopropanol, pentane, hexane, diethyl ether, or combinations thereof. The pre-rinse can include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the pre-rinse contains a 1:1 mixture of acetone to deionized water.

The pre-rinse lasts for about 5 minutes to about 60 minutes, about 10 minutes to about 50 minutes, about 15 minutes to about 45 minutes, about 20 minutes to about 40 minutes, or about 30 minutes. The workpiece 500 can be sonicated while in the pre-rinse. The pre-rinse can be heated and/or maintained at a temperature of about 20° C., about 22° C., about 25° C., about 30° C. to about 35° C., about 40° C., about 50° C., about 80° C., or about 100° C. For example, the pre-rinse can be heated and/or maintained at a temperature of about 20° C. to about 100° C., about 20° C. to about 50° C., or about 20° C. to about 30° C., such as at a room temperature of about 22° C. or about 23° C. After the pre-rinse, the workpiece 500 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more embodiments, prior to operation 610, the workpiece 500 containing the aerospace component 110 can be exposed to the aqueous cleaning solution. The solutions and process conditions described for the aqueous cleaning solution in operations 210 and 220 can be used with the workpiece 500 prior to operation 610.

As depicted in FIG. 5A, the corrosion 132 (e.g., Phase 3 corrosion 132) is contained on the first portion of the aluminum oxide layer 130 while the second portion of the aluminum oxide layer 130 also contains the corrosion 132b below the upper surface of the aluminum oxide layer 130 and extending into the aluminide layer 120. The workpiece also has corrosion 132c extending from the upper surface of the aluminum oxide layer 130, completely through the aluminum oxide layer 130, and into a first or upper portion of the aluminide layer 120. Although not depicted in the FIG. 5A, the corrosion can be below the upper surface of the aluminum oxide layer 130, so not to be visible from above the workpiece, but does not extend into the aluminide layer 120 (e.g., similar to the corrosion 132a depicted in FIG. 3A). The superalloy of the aerospace component 110 is substantially or completely free of the corrosion 132 at Phase 3 of the corrosion.

The aqueous cleaning solution removes the corrosion 132 from the first portion of the aluminum oxide layer 130 to reveal the first portion of the aluminum oxide layer 130 and removes the corrosion 132c from the aluminum oxide layer 130 and the first or upper portion of the aluminide layer 120 to reveal portions of the aluminum oxide layer 130 and the aluminide layer 120, as depicted in FIG. 5B. The aqueous cleaning solution fails to remove the corrosion 132b from below the upper surface of the aluminum oxide layer 130. The first portion of the aluminum oxide layer 130 is typically within one or more voids or spaces 134, 134a formed in the aluminum oxide layer 130 below the upper surface of the aluminum oxide layer 130.

The aqueous cleaning solution contains water, one or more chelators or complexing agents, and one or more bases (e.g., hydroxide). Exemplary chelators or complexing agents can be or include oxalic acid, citric acid, bipyridine, o-phenylenediamine, ethylenediamine (EDA), nitrilotriacetic acid (NTA), iminodiacetic acid, picolinic acid, (1,1,1)-trifluoroacetylacetone, 1,4,7-triazacyclononane (TACN), (N,N,N′,N′-tetrakis(2-pyridinylmethyl)-1,2-ethanediamine (TPEN), ethylenediaminetetraacetic acid (EDTA), ethylenediaminediacetic acid (EDDA), ethylenediamine-N,N′-disuccinic acid (EDDS), ethylenediamine-N,N′-bis(2-hydroxyphenylacetic acid) (EDDHA), 1,4,7,10-tetraazacyclododecane-1,4,7,10-tetraacetic acid (DOTA, 1,2-bis(o-aminophenoxy)ethane-N,N,N′,N′-tetraacetic acid) (BAPTA), aminoethylethanolamine (AEEA), thenoyltrifluoroacetone, salts thereof, adducts thereof, complexes thereof, or any combination thereof. Bases are used to increase the pH of the aqueous cleaning solution and can be or include inorganic bases and/or organic bases. In some examples, one or more hydroxides are used as the base. Exemplary hydroxides can be or include sodium hydroxide, potassium hydroxide, lithium hydroxide, cesium hydroxide, ammonium hydroxide, or any combination thereof. In one or more examples, the complexing agent can be or include EDTA and/or a salt thereof and the base can be or include one or more hydroxides.

In one or more examples, workpiece 500 containing the aerospace component 110 is exposed to the aqueous cleaning solution for about 0.5 hours, about 0.8 hours, about 1 hour, or about 1.5 hours to about 2 hours, about 2.5 hours, about 3 hours, about 4 hours, about 5 hours, or longer. For example, workpiece 500 is exposed to the aqueous cleaning solution for about 0.5 hours to about 5 hours, about 1 hour to about 5 hours, about 2 hours to about 5 hours, about 2.5 hours to about 5 hours, about 3 hours to about 5 hours, about 4 hours to about 5 hours, about 0.5 hours to about 4 hours, about 1 hour to about 4 hours, about 2 hours to about 4 hours, about 2.5 hours to about 4 hours, about 3 hours to about 4 hours, about 0.5 hours to about 3 hours, about 1 hour to about 3 hours, about 2 hours to about 3 hours, or about 2.5 hours to about 3 hours. The workpiece 500 can be sonicated while in the aqueous cleaning solution.

The aqueous cleaning solution can be heated and/or maintained at a temperature of about 20° C., about 22° C., about 25° C., about 30° C. to about 35° C., about 40° C., about 50° C., about 80° C., or about 100° C. For example, the aqueous cleaning solution can be heated and/or maintained at a temperature of about 20° C. to about 100° C., about 20° C. to about 50° C., or about 20° C. to about 30° C., such as at a room temperature of about 22° C. or about 23° C. After operation 620 and before operation 630, the workpiece 500 can optionally be dried, such as air dried at ambient temperature and/or pressure in the air or exposed to a flow of air, nitrogen (N₂), argon, or a mixture thereof from a blower, a fan, or the like at an ambient or heated temperature.

In some examples, after the exposure of the aqueous cleaning solution, the workpiece 500 can be exposed to the rinse, such as with deionized water, one or more organic solvents, or a combination thereof. The workpiece 500 can be exposed to the rinse for about 5 minutes to about 60 minutes, about 10 minutes to about 50 minutes, about 15 minutes to about 45 minutes, about 20 minutes to about 40 minutes, or about 30 minutes. The workpiece 500 can optionally be sonicated while being rinsed. After the rinse, the workpiece 500 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more examples, prior to exposing the workpiece 500 to the acidic cleaning solution, the workpiece 500 is exposed to a pre-rinse for about 5 minutes to about 60 minutes, about 10 minutes to about 45 minutes, or about 20 minutes to about 30 minutes, and the workpiece 500 is sonicated in the pre-rinse, which contains one or more organic solvents and water and is maintained at a temperature of about 20° C. to about 50° C. In other examples, prior to exposing the workpiece 500 to the acidic cleaning solution, the workpiece 500 is exposed to an aqueous cleaning solution for about 1 hour to about 5 hours, and the aerospace component 110 is sonicated in the aqueous cleaning solution, which contains water, one or more complexing agents, and one or more bases and is maintained at a temperature of about 20° C. to about 50° C.

In one or more embodiments, the method 600A of refurbishing an aerospace component 110 includes exposing the workpiece 500 containing corrosion 132 and/or 132a to an acidic cleaning solution at operation 610. At operation 620, the aluminum oxide layer 130, a first or upper portion of the aluminide layer 120, and any corrosion, including corrosion 132, 132b, and/or 132c, are removed from the workpiece 500 by the acidic cleaning solution to reveal a second or lower portion of the aluminide layer 120, as depicted in FIG. 5C.

The acidic cleaning solution contains one or more acids, such as hydrofluoric acid (e.g., hydrogen fluoride), nitric acid, phosphoric acid, hydrochloric acid (e.g., hydrogen chloride), perchloric acid, sulfuric acid, methanesulfonic acid, acetic acid, lactic acid, salts thereof, adducts thereof, complexes thereof, or any combination thereof. The acidic cleaning solution contains water and about 0.1 vol %, about 0.2 vol %, about 0.5 vol %, about 0.8 vol %, about 1 vol %, about 1.5 vol %, about 2 vol %, about 3 vol %, about 4 vol %, about 5 vol %, about 8 vol %, about 10 vol %, about 12 vol %, about 15 vol %, about 18 vol %, or about 20 vol % to about 22 vol %, about 25 vol %, about 30 vol %, about 35 vol %, about 40 vol %, or about 50 vol % of one or more acids. For example, the acidic cleaning solution contains about 0.1 vol % to about 50 vol %, about 0.5 vol % to about 50 vol %, about 1 vol % to about 50 vol %, about 2 vol % to about 50 vol %, about 3 vol % to about 50 vol %, about 5 vol % to about 50 vol %, about 5 vol % to about 40 vol %, about 10 vol % to about 40 vol %, about 15 vol % to about 40 vol %, about 20 vol % to about 40 vol %, about 25 vol % to about 40 vol %, about 30 vol % to about 40 vol %, about 0.1 vol % to about 30 vol %, about 0.5 vol % to about 30 vol %, about 1 vol % to about 30 vol %, about 2 vol % to about 30 vol %, about 3 vol % to about 30 vol %, about 5 vol % to about 30 vol %, about 10 vol % to about 30 vol %, about 15 vol % to about 30 vol %, about 20 vol % to about 30 vol %, about 25 vol % to about 30 vol %, about 28 vol % to about 30 vol %, about 0.1 vol % to about 20 vol %, about 0.5 vol % to about 20 vol %, about 1 vol % to about 20 vol %, about 2 vol % to about 20 vol %, about 3 vol % to about 20 vol %, about 5 vol % to about 20 vol %, about 10 vol % to about 20 vol %, about 15 vol % to about 20 vol %, about 18 vol % to about 20 vol %, about 0.1 vol % to about 10 vol %, about 0.5 vol % to about 10 vol %, about 1 vol % to about 10 vol %, about 2 vol % to about 10 vol %, about 3 vol % to about 10 vol %, about 5 vol % to about 10 vol %, about 6 vol % to about 10 vol %, about 8 vol % to about 10 vol %, about 0.1 vol % to about 5 vol %, about 0.5 vol % to about 5 vol %, about 1 vol % to about 5 vol %, about 2 vol % to about 5 vol %, about 3 vol % to about 5 vol %, or about 4 vol % to about 5 vol %.

In one or more examples, the acidic cleaning solution contains water, hydrogen fluoride, and nitric acid. In some examples, the acidic cleaning solution contains about 0.2 vol % to about 5 vol % of hydrogen fluoride, about 1 vol % to about 10 vol % of nitric acid, and the remainder water. In other examples, the acidic cleaning solution contains about 0.5 vol % to about 3 vol % of hydrogen fluoride, about 2 vol % to about 8 vol % of nitric acid, and the remainder water. In further examples, the acidic cleaning solution contains about 0.8 vol % to about 1.2 vol % of hydrogen fluoride, about 3.5 vol % to about 7 vol % of nitric acid, and the remainder water.

At operations 610 and 620, workpiece 500 containing the aerospace component 110 is exposed to the acidic cleaning solution for about 10 minutes, about 20 minutes, about 30 minutes, about 40 minutes, about 45 minutes, or about 60 minutes to about 70 minutes, about 75 minutes, about 80 minutes, about 90 minutes, about 2 hours, about 2.5 hours, about 3 hours, or about 4 hours. For example, workpiece 500 is exposed to the acidic cleaning solution for about 10 minutes to about 4 hours, about 10 minutes to about 3 hours, about 10 minutes to about 2 hours, about 10 minutes to about 90 minutes, about 10 minutes to about 60 minutes, about 10 minutes to about 45 minutes, about 10 minutes to about 30 minutes, about 10 minutes to about 20 minutes, about 30 minutes to about 4 hours, about 30 minutes to about 3 hours, about 30 minutes to about 2 hours, about 30 minutes to about 90 minutes, about 30 minutes to about 60 minutes, about 30 minutes to about 45 minutes, about 45 minutes to about 4 hours, about 45 minutes to about 3 hours, about 45 minutes to about 2 hours, about 45 minutes to about 90 minutes, or about 45 minutes to about 60 minutes. The workpiece 500 can be mechanically stirred or sonicated while being exposed to the acidic cleaning solution.

The acidic cleaning solution can be heated and/or maintained at a temperature of about 20° C., about 22° C., about 25° C., about 35° C., about 50° C., or about 70° C. to about 80° C., about 90° C., about 100° C., about 120° C., about 150° C., or about 200° C. during operations 610 and 620. For example, the acidic cleaning solution can be heated and/or maintained at a temperature of about 20° C. to about 200° C., about 20° C. to about 100° C., about 20° C. to about 80° C., about 20° C. to about 50° C., about 20° C. to about 40° C., about 20° C. to about 35° C., about 20° C. to about 30° C., about 20° C. to about 25° C., or about 20° C. to about 22° C. during operations 610 and 620. In one or more examples, the aerospace component 110 is exposed to the acidic cleaning solution for about 30 minutes to about 90 minutes or about 45 minutes to about 75 minutes while the acidic cleaning solution is being stirred and maintained at a temperature of about 20° C. to about 50° C., about 22° C. to about 35° C., or about 22° C. to about 25° C.

After operation 620 and before operation 630, the workpiece 500 can optionally be dried, such as air dried at ambient temperature and/or pressure in the air or exposed to a flow of air, nitrogen (N₂), argon, or a mixture thereof from a blower, a fan, or the like at an ambient or heated temperature.

In some examples, after the exposure of the acidic cleaning solution, the workpiece 500 can be exposed to the rinse, such as with deionized water, one or more organic solvents, or a combination thereof. The workpiece 500 can be exposed to the rinse for about 5 minutes to about 60 minutes, about 10 minutes to about 50 minutes, about 15 minutes to about 45 minutes, about 20 minutes to about 40 minutes, or about 30 minutes. The workpiece 500 can optionally be sonicated while being rinsed. After the rinse, the workpiece 500 can optionally be dried, such as air dried at ambient temperature and/or pressure in the air or exposed to a flow of air, nitrogen (N₂), argon, or a mixture thereof from a blower, a fan, or the like at an ambient or heated temperature.

Subsequently, the workpiece 500 containing the aerospace component 110 can be exposed to an aqueous cleaning solution and a drying process as described and discussed herein. In one or more examples, subsequent to exposing the workpiece 500 to the acidic cleaning solution, the workpiece 500 is exposed to a pre-rinse for about 5 minutes to about 60 minutes, about 10 minutes to about 45 minutes, or about 20 minutes to about 30 minutes, and the workpiece 500 is sonicated in the pre-rinse, which contains one or more organic solvents and water and is maintained at a temperature of about 20° C. to about 50° C. In other examples, subsequent to exposing the workpiece 500 to the acidic cleaning solution, the workpiece 500 is exposed to an aqueous cleaning solution for about 1 hour to about 5 hours, and the aerospace component 110 is sonicated in the aqueous cleaning solution, which contains water, one or more complexing agents, and one or more bases and is maintained at a temperature of about 20° C. to about 50° C.

At operation 630, the workpiece 500 can be exposed to a post-rinse which contains one or more organic solvents and water. Exemplary organic solvents can be or include acetone, methanol, ethanol, isopropanol, pentane, hexane, diethyl ether, or combinations thereof. The post-rinse can include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the post-rinse contains a 1:1 mixture of acetone to deionized water.

The post-rinse lasts for about 5 minutes to about 3 hours, about 20 minutes to about 2 hours, about 30 minutes to about 90 minutes, about 45 minutes to about 75 minutes, such as about 60 minutes. The workpiece 500 can be sonicated while in the post-rinse. The post-rinse can be heated and/or maintained at a temperature of about 20° C., about 22° C., about 25° C., about 30° C. to about 35° C., about 40° C., about 50° C., about 80° C., or about 100° C. For example, the post-rinse can be heated and/or maintained at a temperature of about 20° C. to about 100° C., about 20° C. to about 50° C., or about 20° C. to about 30° C., such as at a room temperature of about 22° C. or about 23° C.

At operation 630, the workpiece 500 can optionally be dried, such as air dried at ambient temperature and/or pressure in the air or exposed to a flow of air, nitrogen (N₂), argon, or a mixture thereof from a blower, a fan, or the like at an ambient or heated temperature.

In one or more examples, the aluminide layer 120 is exposed to the post-rinse for about 10 minutes to about 90 minutes, the workpiece 500 is sonicated in the post-rinse, and the post-rinse contains one or more organic solvents and water and is maintained at a temperature of about 20° C. to about 50° C.

At operation 650, a protective coating 140 can be deposited or otherwise formed on the workpiece 500, such as on the aluminide layer 120, as depicted in FIG. 5D. The protective coating 140 is deposited or otherwise formed conformally over and on the aluminide layer 120. In one or more embodiments, the protective coating 140 contains one or more of chromium oxide, aluminum oxide, aluminum nitride, hafnium oxide, titanium oxide, titanium nitride, tantalum oxide, tantalum nitride, dopants thereof, or any combination thereof. In other embodiments, the protective coating 140 can be or include any one or more of the protective coatings, the nanolaminate film stacks, materials, layers, or combinations thereof described and discussed herein. The protective coating 140 has a thickness of about 1 nm to about 10,000 nm, as further described and discussed below.

FIG. 6B is a flow chart illustrating a method 600B, which is an exemplary version of the method 600A with optional operations during the refurbishing process. In one or more examples, the workpiece 500 containing the aerospace component 110 having corrosion at Phase 3 can be treated by the method 600B, which include: (1) exposing the workpiece 500 to a pre-rinse; optionally drying the workpiece 500; (2) optionally exposing the workpiece 500 including the aluminum oxide layer 130 to an aqueous cleaning solution; optionally drying the workpiece 500; (3) optionally exposing the workpiece 500 including the aluminum oxide layer 130 to another rinse (e.g., water or mixture of water and organic solvent similar to pre-rinse or post rinse); optionally drying the workpiece 500; (4) exposing the workpiece 500 including the aluminum oxide layer 130 to one or more acids, a mixture of acids, and/or an acidic cleaning solution containing a mixture of hydrofluoric acid and nitric acid (e.g., HF:HNO₃ mixture); optionally drying the workpiece 500; (5) optionally exposing the workpiece 500 including the aluminum oxide layer 130 to another rinse (e.g., water or mixture of water and organic solvent similar to pre-rinse or post rinse); optionally drying the workpiece 500; (6) optionally exposing the workpiece 500 to an aqueous cleaning solution; optionally drying the workpiece 500; (7) exposing the workpiece 500 including the aluminum oxide layer 130 to a post-rinse; optionally drying the workpiece 500; and (8) forming the protective coating 140 over and on at least a portion (e.g., second portion) of the aluminide layer 120.

In some examples, the method 600B can include: (1a) exposing the workpiece 500 to a pre-rinse containing a combination of deionized water and one or more organic solvents while sonicating at room temperature (e.g., about 23° C.) for about 30 minutes; (1b) drying the workpiece 500 with nitrogen gas from a nitrogen gun; (2a) optionally exposing the workpiece 500 including the aluminum oxide layer 130 to an aqueous cleaning solution containing a combination of one or more chelating agents and one or more alkaline solutions while sonicating at room temperature (e.g., about 23° C.) for about 3 hours; (2b) drying the workpiece 500 with nitrogen gas from a nitrogen gun; (3a) exposing the workpiece 500 including the aluminum oxide layer 130 to a rinse containing deionized water while sonicating for about 1 hour; (3b) drying the workpiece 500 with nitrogen gas from a nitrogen gun; (4a) exposing the workpiece 500 including the aluminum oxide layer 130 to an acidic cleaning solution (e.g., HF:HNO₃ mixture containing contains about 0.8 vol % to about 1.2 vol % of hydrogen fluoride, about 3.5 vol % to about 7 vol % of nitric acid, and the remainder water) while mechanically stirring at room temperature (e.g., about 23° C.) for about 1 hour; (4b) drying the workpiece 500 with nitrogen gas from a nitrogen gun; (5a) exposing the workpiece 500 including the aluminum oxide layer 130 to a rinse containing deionized water while sonicating for about 1 hour; (5b) drying the workpiece 500 with nitrogen gas from a nitrogen gun; (6a) exposing the workpiece 500 to an aqueous cleaning solution containing a combination of one or more chelating agents and one or more alkaline solutions while sonicating at room temperature (e.g., about 23° C.) for about 3 hours; drying the workpiece 500 with nitrogen gas from a nitrogen gun; (7a) exposing the workpiece 500 including the aluminum oxide layer 130 to a post-rinse containing a combination of deionized water and one or more organic solvents while sonicating at room temperature (e.g., about 23° C.) for about 60 minutes; (7b) drying the workpiece 500 with nitrogen gas from a nitrogen gun; and (8) forming the protective coating 140 over and on a second portion of the aluminide layer 120.

FIG. 6C is a flow chart illustrating a method 600C for detecting an end-point of a cleaning process, according to one or more embodiments described and discussed herein. The method 600C, and variations thereof, can be used in conjunction with the method 600A while cleaning workpieces and/or aerospace components during a refurbishing process. In one or more examples, the workpiece 500 containing the aerospace component 110 having corrosion at Phase 3 can be treated by the method 600C. Embodiments of the method 600C can be used to detect the end-point of the cleaning process, in part, by monitoring and analyzing samples or aliquots of the rinses during the cleaning processes. The rinses can be analyzed by UV-vis absorbance spectroscopy which can be used on a real-time analysis of the rinse and/or of samples or aliquots of the rinse. In some examples, corrosion, oxidation, and/or other contaminants are contained on or within at least one of the aluminum oxide layer 130 or the aluminide layer 120 of the workpiece 500 containing the aerospace component 110.

In one or more embodiments, the method 600C, can be used to detect an end-point of a cleaning process by conducting operations 660-685. The method 600C includes analyzing a reference solvent by absorbance spectroscopy to determine a reference solute concentration of the reference solvent (operation 660). The reference solvent contains the same solvent (e.g., water, one or more organic solvents, or any combination thereof) which will be used in the subsequent samples or aliquots to be analyzed by absorbance spectroscopy. In one or more examples, the reference solvent is removed from the solvent source and directly analyzed by absorbance spectroscopy without exposing the solvent to any aerospace components to determine the reference solute concentration. In other examples, the reference solvent is removed from the solvent source, then exposed to a new aerospace component without corrosion similar to the aerospace component being tested (e.g., same part and/or same coatings), and then the reference solvent is analyzed by absorbance spectroscopy (e.g., UV-vis) for the reference solute concentration.

The method 600C further includes exposing the aerospace component with corrosion to sonication in a first solvent (operation 661), exposing the aerospace component to a first water rinse (operation 662), and analyzing a first aliquot of the first water rinse by absorbance spectroscopy to determine a first intermediate solute concentration in the first aliquot (operation 663). The first intermediate solute concentration can be greater than the reference solute concentration. The method 600C further includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 664).

The method 600C also includes exposing the aerospace component to a first aqueous cleaning solution to remove the corrosion from the aluminum oxide layer (operation 665), then exposing the aerospace component to an optional supplemental water rinse (operation 666), and optionally drying the aerospace component at ambient temperature and/or pressure or by exposure to a gas (e.g., air, nitrogen (N₂), argon, or mixtures thereof), such as exposing to nitrogen gas from a nitrogen gun (operation 667).

The method 600C further includes exposing the aerospace component to a first sonication in water (operation 668), exposing the aerospace component to a second water rinse (operation 669), and analyzing a second aliquot of the second water rinse by absorbance spectroscopy to determine a second intermediate solute concentration in the second aliquot (operation 670). The second intermediate solute concentration can be less than the first intermediate solute concentration. The method 600C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 671).

The method 600C also includes exposing the aerospace component to an acidic cleaning solution to remove the corrosion from the aluminum oxide layer and/or or the aluminide layer (operation 672), and then exposing the aerospace component to an optional supplemental water rinse (operation 673). In one or more embodiments, the method 600C includes exposing the aerospace component to the acidic cleaning solution for about 20 minutes to about 120 minutes, about 30 minutes to about 90 minutes, or about 45 minutes to about 75 minutes, stirring (e.g., mechanically stirring) or otherwise agitating the acidic cleaning solution while exposing the aerospace component, and maintaining the acidic cleaning solution at a temperature of less than 50° C., such as about 20° C. to less than 50° C., about 23° C. to about 48° C., about 25° C. to about 45° C., about 25° C. to about 40° C., or about 25° C. to about 35° C. In one or more examples, the acidic cleaning solution contains water, hydrogen fluoride, and nitric acid. In some examples, the acidic cleaning solution contains about 0.2 volume percent (vol %) to about 5 vol % of hydrogen fluoride and about 1 vol % to about 10 vol % of nitric acid. The method 600C further includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 674).

The method 600C further includes exposing the aerospace component to a second sonication in water (operation 675), exposing the aerospace component to a third water rinse (operation 676), and analyzing a third aliquot of the third water rinse by absorbance spectroscopy to determine a third intermediate solute concentration in the third aliquot (operation 677). The third intermediate solute concentration can be less than the second intermediate solute concentration. The method 600C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 678).

The method 600C further includes exposing the aerospace component to a second aqueous cleaning solution to remove the corrosion from the aluminum oxide layer and/or or the aluminide layer (operation 679) and exposing the aerospace component to an optional supplemental water rinse (operation 680). The method 600C also includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 681).

The method 600C further includes exposing the aerospace component to a second solvent (operation 682), exposing the aerospace component to a fourth water rinse (operation 683), and analyzing a fourth aliquot of the fourth water rinse by absorbance spectroscopy to determine a post-clean solute concentration in the fourth aliquot (operation 684). The post-clean solute concentration can be less than the third intermediate solute concentration. Each of the first aliquot, the second aliquot, the third aliquot, and the fourth aliquot is independently analyzed by one or more absorbance spectroscopies, such as UV-vis absorbance spectroscopy. The method 600C includes optionally drying the aerospace component at ambient temperature and/or pressure or by exposure to a gas (e.g., air, nitrogen (N₂), argon, or mixtures thereof), such as exposing to nitrogen gas from a nitrogen gun (operation 685).

In one or more embodiments, the method 600C includes exposing the aerospace component to the acidic cleaning solution for about 20 minutes to about 120 minutes, about 30 minutes to about 90 minutes, or about 45 minutes to about 75 minutes, stirring (e.g., mechanically stirring) or otherwise agitating the acidic cleaning solution while exposing the aerospace component, and maintaining the acidic cleaning solution at a temperature of about 20° C. to about 50° C. or about 22° C. to about 25° C.

In other embodiments, the method 600C includes exposing the aerospace component to the first solvent and/or the second solvent for about 5 minutes to about 60 minutes, about 10 minutes to about 45 minutes, or about 20 minutes to about 30 minutes, while sonicating the aerospace component in the first solvent and/or the second solvent, and maintaining the first solvent and/or the second solvent at a temperature of about 20° C. to about 50° C. or about 22° C. to about 25° C. The first solvent and/or the second solvent can be an aqueous solvent solution, an organic solvent solution, or a mixture thereof. In one or more examples, the first solvent and/or the second solvent independently contains one or more organic solvents. In other examples, the first solvent and/or the second solvent independently contains water (e.g., deionized water) and one or more organic solvents. Exemplary organic solvents can be or include acetone, methanol, ethanol, isopropanol, pentane, hexane, diethyl ether, or combinations thereof. The first solvent and/or the second solvent independently include about 10 vol %, about 20 vol %, about 30 vol %, about 40 vol %, or about 50 vol % to about 60 vol %, about 70 vol %, about 80 vol %, about 90 vol %, or about 100 vol % of the solvent and the remainder is water. In one or more examples, the first solvent and/or the second solvent independently contains a 1:1 mixture of acetone to deionized water.

In some embodiments, the method 600C includes exposing the aerospace component to deionized water for about 5 minutes to about 60 minutes, about 10 minutes to about 45 minutes, or about 20 minutes to about 30 minutes, while sonicating the aerospace component in the deionized water, and maintaining the deionized water at a temperature of about 20° C. to about 50° C. or about 22° C. to about 25° C.

Each of the first aqueous cleaning solution and/or the second aqueous cleaning solution independently contains water, one or more complexing agents, and one or more bases. In some examples, the complexing agent contains EDTA and/or a salt thereof, and the base contains one or more hydroxides. The method further includes exposing the aerospace component to the first and/or second aqueous cleaning solution for about 1 hour to about 5 hours, sonicating the aerospace component in the first and/or second aqueous cleaning solution, and maintaining the first and/or second aqueous cleaning solution at a temperature of about 20° C. to about 50° C. or about 22° C. to about 25° C.

### Alternative Clean Processes

Prior to depositing or otherwise forming the protective coating 140 at operations 250, 450, 650, the workpiece 100, 300, 500 can optionally be exposed to one or more cleaning processes. One or more contaminants are removed from the aerospace component to produce the cleaned surface during the cleaning process. The contaminant can be or include acids, bases, oxides, organics or organic residues, carbon, oil, soil, particulates, debris, and/or other contaminants, or any combination thereof. These contaminants are removed prior to producing the protective coating 140 on the workpiece 100, 300, 500.

The cleaning process can be or include one or more basting or texturing processes, vacuum purges, solvent clean, acid clean, basic or caustic clean, wet clean, ozone clean, plasma clean, sonication, or any combination thereof. Once cleaned and/or textured, the subsequently deposited protective coating has stronger adhesion to the cleaned surfaces or otherwise altered surfaces of the workpiece 100, 300, 500 than if otherwise not exposed to the cleaning process.

In one or more examples, the surfaces of the workpiece 100, 300, 500 can be blasted with or otherwise exposed to beads, sand, carbonate, or other particulates to remove oxides and other contaminates therefrom and/or to provide texturing to the surfaces of the aerospace component. In some examples, the workpiece 100, 300, 500 can be placed into a chamber within a pulsed push-pull system and exposed to cycles of purge gas or liquid (e.g., N₂, Ar, He, one or more alcohols (methanol, ethanol, propanol, and/or others), H₂O, or any combination thereof) and vacuum purges to remove debris from small holes on the workpiece 100, 300, 500. In other examples, the surfaces of the workpiece 100, 300, 500 can be exposed to hydrogen plasma, oxygen or ozone plasma, and/or nitrogen plasma, which can be generated in a plasma chamber or by a remote plasma system.

In some examples, such as for organic removal or oxide removal, the surfaces of the workpiece 100, 300, 500 can be exposed to a hydrogen plasma, then degassed, then exposed to ozone treatment. In other examples, such as for organic removal, the surfaces of the workpiece 100, 300, 500 can be exposed to a wet clean that includes: soaking in an alkaline degreasing solution, rinsing, exposing the surfaces to an acid clean (e.g., sulfuric acid, phosphoric acid, hydrochloric acid, hydrofluoric acid, or any combination thereof), rinsing, and exposing the surfaces to a deionized water sonication bath. In some examples, such as for oxide removal, the surfaces of the workpiece 100, 300, 500 can be exposed to a wet clean that includes: exposing the surfaces to a dilute acid solution (e.g., acetic acid hydrochloric acid, hydrofluoric acid, or combinations thereof), rinsing, and exposing the surfaces to a deionized water sonication bath. In one or more examples, such as for particle removal, the surfaces of the workpiece 100, 300, 500 can be exposed to sonication (e.g., megasonication) and/or a supercritical fluid (carbon dioxide, water, one or more alcohols) wash, followed by exposing to cycles of purge gas or liquid (e.g., air, N₂, Ar, He, one or more alcohols, water, or any combination thereof) and vacuum purges to remove particles from and dry the surfaces. In some examples, the workpiece 100, 300, 500 can be exposed to heating or drying processes, such as heating the workpiece 100, 300, 500 to a temperature of about 50° C., about 65° C., or about 80° C. to about 100° C., about 120° C., or about 150° C. and exposing to surfaces to the purge gas (e.g., air, N₂, Ar, He, or any combination thereof). The workpiece 100, 300, 500 can be heated in an oven or exposed to lamps for the heating or drying processes. Optionally, hot gas can be forced through internal passages to accelerate drying. Optionally, the component can be dried in reduced atmosphere without heating or with heating. In various embodiments, the cleaned surface of the workpiece 100, 300, 500 can be one or more interior surfaces and/or one or more exterior surfaces of the workpiece 100, 300, 500.

### Vapor Deposition Process

In one or more embodiments, a method for depositing a protective coating on an aerospace component includes sequentially exposing the aerospace component to an aluminum precursor and one or more reactants to form an aluminum-containing layer on a surface of the aerospace component by an ALD process or a PE-ALD. In other embodiments, a method for depositing a protective coating on an aerospace component includes simultaneously exposing the aerospace component to an aluminum precursor and one or more reactants to form an aluminum-containing layer on a surface of the aerospace component by a CVD process or a PE-CVD. In some examples, the reactant can be or contain one or more oxidizing agents and/or one or more nitriding agents. The oxidizing agent can be or contain water, ozone, oxygen (O₂), atomic oxygen, nitrous oxide, one or more peroxides (e.g., hydrogen peroxide, other inorganic peroxides, organic peroxides), one or more alcohols (e.g., methanol, ethanol, propanol, or higher alcohols), plasmas thereof, or any combination thereof. The nitriding agent can be or contain ammonia, nitric oxide, atomic nitrogen, a hydrazine, plasmas thereof, or any combination thereof. The aluminum-containing layer contains aluminum oxide, aluminum nitride, aluminum oxynitride, or any combination thereof.

In other embodiments, a method for depositing a protective coating on an aerospace component includes sequentially exposing the aerospace component to a chromium precursor and a reactant to form a chromium-containing layer on a surface of the aerospace component by an ALD process. The chromium-containing layer contains metallic chromium, chromium oxide, chromium nitride, chromium carbide, chromium silicide, or any combination thereof.

In some embodiments, a nanolaminate film stack is formed on the surface of the aerospace component, where the nanolaminate film stack contains alternating layers of the chromium-containing layer and a second deposited layer. The aerospace component can be sequentially exposed to a metal or silicon precursor and a second reactant to form the second deposited layer on the surface by ALD. The second deposited layer contains aluminum oxide, aluminum nitride, silicon oxide, silicon nitride, silicon carbide, yttrium oxide, yttrium nitride, yttrium silicon nitride, hafnium oxide, hafnium nitride, hafnium silicide, hafnium silicate, titanium oxide, titanium nitride, titanium silicide, titanium silicate, or any combination thereof. The nanolaminate film stack containing the alternating layers of the chromium-containing layer and the second deposited layer can be used as the protective coating on the aerospace component. Alternatively, in other embodiments, the nanolaminate film stack disposed on the aerospace component can be exposed to an annealing process to convert the nanolaminate film stack into a coalesced film, which can be used as the protective coating on the aerospace component.

In one or more embodiments, the protective coating contains a nanolaminate film stack containing one pair or a plurality of pairs of a first deposited layer and a second deposited layer sequentially deposited or otherwise formed on the aerospace component. The nanolaminate film stack is illustrated with four pairs of the first and second deposited layers, however, the nanolaminate film stack can contain any number of the first and second deposited layers, as further discussed below. For example, the nanolaminate film stack can contain from one pair of the first and second deposited layers to about 150 pairs of the first and second deposited layers. In other embodiments, not shown, the protective coating is not a nanolaminate film stack, but instead contains the first deposited layer or the second deposited layer deposited or otherwise formed on the aerospace component. In further embodiments, the nanolaminate film stack containing one or more pairs of the first and second deposited layers are initially deposited, then is converted to a coalesced film or a crystalline film.

In other embodiments, the protective coating contains a nanolaminate film stack. The nanolaminate film stack contains a first deposited layer and a second deposited layer, and the method further includes depositing from 2 pairs to about 500 pairs of the first deposited layer and the second deposited layer while increasing a thickness of the nanolaminate film stack. In one or more examples, each pair of the first deposited layer and the second deposited layer can have a thickness of about 0.2 nm to about 500 nm. In some examples, the method further includes annealing the aerospace component and converting the nanolaminate film stack into a coalesced film or a crystalline film.

The aerospace component can be exposed to a first precursor and a first reactant to form the first deposited layer on the aerospace component by a vapor deposition process. The vapor deposition process can be an ALD process, a plasma-enhanced ALD (PE-ALD) process, a thermal chemical vapor deposition (CVD) process, a plasma-enhanced CVD (PE-CVD) process, a pulsed-CVD process, or any combination thereof.

In one or more embodiments, the vapor deposition process is an ALD process and the method includes sequentially exposing the surface of the aerospace component to the first precursor and the first reactant to form the first deposited layer. Each cycle of the ALD process includes exposing the surface of the aerospace component to the first precursor, conducting a pump-purge, exposing the aerospace component to the first reactant, and conducting a pump-purge to form the first deposited layer. The order of the first precursor and the first reactant can be reversed, such that the ALD cycle includes exposing the surface of the aerospace component to the first reactant, conducting a pump-purge, exposing the aerospace component to the first precursor, and conducting a pump-purge to form the first deposited layer.

In some examples, during each ALD cycle, the aerospace component is exposed to the first precursor for about 0.1 seconds to about 10 seconds, the first reactant for about 0.1 seconds to about 10 seconds, and the pump-purge for about 0.5 seconds to about 30 seconds. In other examples, during each ALD cycle, the aerospace component is exposed to the first precursor for about 0.5 seconds to about 3 seconds, the first reactant for about 0.5 seconds to about 3 seconds, and the pump-purge for about 1 second to about 10 seconds.

Each ALD cycle is repeated from 2, 3, 4, 5, 6, 8, about 10, about 12, or about 15 times to about 18, about 20, about 25, about 30, about 40, about 50, about 65, about 80, about 100, about 120, about 150, about 200, about 250, about 300, about 350, about 400, about 500, about 800, about 1,000, or more times to form the first deposited layer. For example, each ALD cycle is repeated from 2 times to about 1,000 times, 2 times to about 800 times, 2 times to about 500 times, 2 times to about 300 times, 2 times to about 250 times, 2 times to about 200 times, 2 times to about 150 times, 2 times to about 120 times, 2 times to about 100 times, 2 times to about 80 times, 2 times to about 50 times, 2 times to about 30 times, 2 times to about 20 times, 2 times to about 15 times, 2 times to about 10 times, 2 times to 5 times, about 8 times to about 1,000 times, about 8 times to about 800 times, about 8 times to about 500 times, about 8 times to about 300 times, about 8 times to about 250 times, about 8 times to about 200 times, about 8 times to about 150 times, about 8 times to about 120 times, about 8 times to about 100 times, about 8 times to about 80 times, about 8 times to about 50 times, about 8 times to about 30 times, about 8 times to about 20 times, about 8 times to about 15 times, about 8 times to about 10 times, about 20 times to about 1,000 times, about 20 times to about 800 times, about 20 times to about 500 times, about 20 times to about 300 times, about 20 times to about 250 times, about 20 times to about 200 times, about 20 times to about 150 times, about 20 times to about 120 times, about 20 times to about 100 times, about 20 times to about 80 times, about 20 times to about 50 times, about 20 times to about 30 times, about 50 times to about 1,000 times, about 50 times to about 500 times, about 50 times to about 350 times, about 50 times to about 300 times, about 50 times to about 250 times, about 50 times to about 150 times, or about 50 times to about 100 times to form the first deposited layer.

In other embodiments, the vapor deposition process is a CVD process and the method includes simultaneously exposing the aerospace component to the first precursor and the first reactant to form the first deposited layer. During an ALD process or a CVD process, each of the first precursor and the first reactant can independently include one or more carrier gases. One or more purge gases can be flowed across the aerospace component and/or throughout the processing chamber in between the exposures of the first precursor and the first reactant. In some examples, the same gas may be used as a carrier gas and a purge gas. Exemplary carrier gases and purge gases can independently be or include one or more of nitrogen (N₂), argon, helium, neon, hydrogen (H₂), or any combination thereof.

The first deposited layer can have a thickness of about 0.1 nm, about 0.2 nm, about 0.3 nm, about 0.4 nm, about 0.5 nm, about 0.8 nm, about 1 nm, about 2 nm, about 3 nm, about 5 nm, about 8 nm, about 10 nm, about 12 nm, or about 15 nm to about 18 nm, about 20 nm, about 25 nm, about 30 nm, about 40 nm, about 50 nm, about 60 nm, about 80 nm, about 100 nm, about 120 nm, or about 150 nm. For example, the first deposited layer can have a thickness of about 0.1 nm to about 150 nm, about 0.2 nm to about 150 nm, about 0.2 nm to about 120 nm, about 0.2 nm to about 100 nm, about 0.2 nm to about 80 nm, about 0.2 nm to about 50 nm, about 0.2 nm to about 40 nm, about 0.2 nm to about 30 nm, about 0.2 nm to about 20 nm, about 0.2 nm to about 10 nm, about 0.2 nm to about 5 nm, about 0.2 nm to about 1 nm, about 0.2 nm to about 0.5 nm, about 0.5 nm to about 150 nm, about 0.5 nm to about 120 nm, about 0.5 nm to about 100 nm, about 0.5 nm to about 80 nm, about 0.5 nm to about 50 nm, about 0.5 nm to about 40 nm, about 0.5 nm to about 30 nm, about 0.5 nm to about 20 nm, about 0.5 nm to about 10 nm, about 0.5 nm to about 5 nm, about 0.5 nm to about 1 nm, about 2 nm to about 150 nm, about 2 nm to about 120 nm, about 2 nm to about 100 nm, about 2 nm to about 80 nm, about 2 nm to about 50 nm, about 2 nm to about 40 nm, about 2 nm to about 30 nm, about 2 nm to about 20 nm, about 2 nm to about 10 nm, about 2 nm to about 5 nm, about 2 nm to about 3 nm, about 10 nm to about 150 nm, about 10 nm to about 120 nm, about 10 nm to about 100 nm, about 10 nm to about 80 nm, about 10 nm to about 50 nm, about 10 nm to about 40 nm, about 10 nm to about 30 nm, about 10 nm to about 20 nm, or about 10 nm to about 15 nm.

In one or more embodiments, the first precursor contains one or more chromium precursors, one or more aluminum precursors, or one or more hafnium precursors. The first reactant contains one or more reducing agents, one or more oxidizing agents, one or more nitriding agents, one or more silicon precursors, one or more carbon precursors, or any combination thereof. In some examples, the first deposited layer is a chromium-containing layer which can be or include metallic chromium, chromium oxide, chromium nitride, chromium silicide, chromium carbide, or any combination thereof. In other examples, the first deposited layer is an aluminum-containing layer which can be or include metallic aluminum, aluminum oxide, aluminum nitride, aluminum silicide, aluminum carbide, or any combination thereof. In further examples, the first deposited layer is a hafnium-containing layer which can be or include metallic hafnium, hafnium oxide, hafnium nitride, hafnium silicide, hafnium carbide, or any combination thereof.

The chromium precursor can be or include one or more of chromium cyclopentadiene compounds, chromium carbonyl compounds, chromium acetylacetonate compounds, chromium diazadienyl compounds, substitutes thereof, complexes thereof, abducts thereof, salts thereof, or any combination thereof. Exemplary chromium precursor can be or include bis(cyclopentadiene) chromium (Cp₂Cr), bis(pentamethylcyclopentadiene) chromium ((Me5Cp)₂Cr), bis(isopropylcyclopentadiene) chromium ((iPrCp)₂Cr), bis(ethylbenzene) chromium ((EtBz)₂Cr), chromium hexacarbonyl (Cr(CO)₆), chromium acetylacetonate (Cr(acac)₃, also known as, tris(2,4-pentanedione) chromium), chromium hexafluoroacetylacetonate (Cr(hfac)₃), chromium(III) tris(2,2,6,6-tetramethyl-3,5-heptanedionate) {Cr(tmhd)₃}, chromium(II) bis(1,4-ditertbutyldiazadienyl), isomers thereof, complexes thereof, abducts thereof, salts thereof, or any combination thereof.

The aluminum precursor can be or include one or more of aluminum alkyl compounds, one or more of aluminum alkoxy compounds, one or more of aluminum acetylacetonate compounds, substitutes thereof, complexes thereof, abducts thereof, salts thereof, or any combination thereof. Exemplary aluminum precursors can be or include trimethylaluminum, triethylaluminum, tripropylaluminum, tributylaluminum, trimethoxyaluminum, triethoxyaluminum, tripropoxyaluminum, tributoxyaluminum, aluminum acetylacetonate (Al(acac)₃, also known as, tris(2,4-pentanedione) aluminum), aluminum hexafluoroacetylacetonate (Al(hfac)₃), trisdipivaloylmethanatoaluminum (DPM₃Al; (C₁₁H₁₉O₂)₃Al), isomers thereof, complexes thereof, abducts thereof, salts thereof, or any combination thereof.

In one or more examples, the precursor is or contains one or more aluminum alkyl compounds, such as trimethyl aluminum (TMA). The aluminum alkyl compound (e.g., TMA) has a purity of greater than 95%, greater than 97%, or greater than 99%, such as about 99.3%, about 99.5 wt %, about 99.7 wt %, or about 99.9 wt % to about 99.95 wt %, about 99.99 wt %, about 99.995 wt %, about 99.999 wt %, about 99.9999 wt %, or greater. In one or more examples, the aluminum alkyl compound (e.g., TMA) has a purity of 99.5 wt % or greater, such as about 99.9 wt % to about 99.999 wt %.

The hafnium precursor can be or include one or more of hafnium cyclopentadiene compounds, one or more of hafnium amino compounds, one or more of hafnium alkyl compounds, one or more of hafnium alkoxy compounds, substitutes thereof, complexes thereof, abducts thereof, salts thereof, or any combination thereof. Exemplary hafnium precursors can be or include bis(methylcyclopentadiene) dimethylhafnium ((MeCp)₂HfMe₂), bis(methylcyclopentadiene) methylmethoxyhafnium ((MeCp)₂Hf(OMe)(Me)), bis(cyclopentadiene) dimethylhafnium ((Cp)₂HfMe₂), tetra(tert-butoxy) hafnium, hafnium isopropoxide ((iPrO)₄Hf), tetrakis(dimethylamino) hafnium (TDMAH), tetrakis(diethylamino) hafnium (TDEAH), tetrakis(ethylmethylamino) hafnium (TEMAH), isomers thereof, complexes thereof, abducts thereof, salts thereof, or any combination thereof.

The titanium precursor can be or include one or more of titanium cyclopentadiene compounds, one or more of titanium amino compounds, one or more of titanium alkyl compounds, one or more of titanium alkoxy compounds, substitutes thereof, complexes thereof, abducts thereof, salts thereof, or any combination thereof. Exemplary titanium precursors can be or include bis(methylcyclopentadiene) dimethyltitanium ((MeCp)₂TiMe₂), bis(methylcyclopentadiene) methylmethoxytitanium ((MeCp)₂Ti(OMe)(Me)), bis(cyclopentadiene) dimethyltitanium ((Cp)₂TiMe₂), tetra(tert-butoxy) titanium, titanium isopropoxide ((iPrO)₄Ti), tetrakis(dimethylamino) titanium (TDMAT), tetrakis(diethylamino) titanium (TDEAT), tetrakis(ethylmethylamino) titanium (TEMAT), isomers thereof, complexes thereof, abducts thereof, salts thereof, or any combination thereof.

In one or more examples, the first deposited layer is a chromium-containing layer which can be or include metallic chromium and the first reactant contains one or more reducing agents. In some examples, the first deposited layer is an aluminum-containing layer which can be or include metallic aluminum and the first reactant contains one or more reducing agents. In other examples, the first deposited layer is a hafnium-containing layer which can be or include metallic hafnium and the first reactant contains one or more reducing agents. Exemplary reducing agents can be or include hydrogen (H₂), ammonia, hydrazine, one or more hydrazine compounds, one or more alcohols, a cyclohexadiene, a dihydropyrazine, an aluminum containing compound, abducts thereof, salts thereof, plasma derivatives thereof, or any combination thereof.

In some examples, the first deposited layer is a chromium-containing layer which can be or include chromium oxide and the first reactant contains one or more oxidizing agents. In other examples, the first deposited layer is an aluminum-containing layer which can be or include aluminum oxide and the first reactant contains one or more oxidizing agents. In further examples, the first deposited layer is a hafnium-containing layer which can be or include hafnium oxide and the first reactant contains one or more oxidizing agents. Exemplary oxidizing agents can be or include water (e.g., steam), oxygen (O₂), atomic oxygen, ozone, nitrous oxide, one or more peroxides, one or more alcohols, plasmas thereof, or any combination thereof.

In one or more examples, the first deposited layer is a chromium-containing layer which can be or include chromium nitride and the first reactant contains one or more nitriding agents. In other examples, the first deposited layer is an aluminum-containing layer which can be or include aluminum nitride and the first reactant contains one or more nitriding agents. In some examples, the first deposited layer is a hafnium-containing layer which can be or include hafnium nitride and the first reactant contains one or more nitriding agents. Exemplary nitriding agents can be or include ammonia, atomic nitrogen, one or more hydrazines, nitric oxide, plasmas thereof, or any combination thereof.

In one or more examples, the first deposited layer is a chromium-containing layer which can be or include chromium silicide and the first reactant contains one or more silicon precursors. In some examples, the first deposited layer is an aluminum-containing layer which can be or include aluminum silicide and the first reactant contains one or more silicon precursors. In other examples, the first deposited layer is a hafnium-containing layer which can be or include hafnium silicide and the first reactant contains one or more silicon precursors. Exemplary silicon precursors can be or include silane, disilane, trisilane, tetrasilane, pentasilane, hexasilane, monochlorosilane, dichlorosilane, trichlorosilane, tetrachlorosilane, hexachlorosilane, substituted silanes, plasma derivatives thereof, or any combination thereof.

In some examples, the first deposited layer is a chromium-containing layer which can be or include chromium carbide and the first reactant contains one or more carbon precursors. In other examples, the first deposited layer is an aluminum-containing layer which can be or include aluminum carbide and the first reactant contains one or more carbon precursors. In further examples, the first deposited layer is a hafnium-containing layer which can be or include hafnium carbide and the first reactant contains one or more carbon precursors. Exemplary carbon precursors can be or include one or more alkanes, one or more alkenes, one or more alkynes, substitutes thereof, plasmas thereof, or any combination thereof.

In some embodiments, the aerospace component can be exposed to a second precursor and a second reactant to form the second deposited layer on the first deposited layer by an ALD process producing nanolaminate film. The first deposited layer and second deposited layer have different compositions from each other. In some examples, the first precursor is a different precursor than the second precursor, such as that the first precursor is a source of a first type of metal and the second precursor is a source of a second type of metal and the first and second types of metal are different.

The second precursor can be or include one or more aluminum precursors, one or more hafnium precursors, one or more yttrium precursors, or any combination thereof. The second reactant can be any other reactants used as the first reactant. For example, the second reactant can be or include one or more reducing agents, one or more oxidizing agents, one or more nitriding agents, one or more silicon precursors, one or more carbon precursors, or any combination thereof, as described and discussed above. During the ALD process, each of the second precursor and the second reactant can independently include one or more carrier gases. One or more purge gases can be flowed across the aerospace component and/or throughout the processing chamber in between the exposures of the second precursor and the second reactant. In some examples, the same gas may be used as a carrier gas and a purge gas. Exemplary carrier gases and purge gases can independently be or include one or more of nitrogen (N₂), argon, helium, neon, hydrogen (H₂), or any combination thereof.

In one or more embodiments, the second deposited layer contains aluminum oxide, aluminum nitride, silicon oxide, silicon nitride, silicon carbide, yttrium oxide, yttrium nitride, yttrium silicon nitride, hafnium oxide, hafnium nitride, hafnium silicide, hafnium silicate, titanium oxide, titanium nitride, titanium silicide, titanium silicate, or any combination thereof. In one or more examples, if the first deposited layer contains aluminum oxide or aluminum nitride, then the second deposited layer does not contain aluminum oxide or aluminum nitride. Similarly, if the first deposited layer contains hafnium oxide or hafnium nitride, then the second deposited layer does not contain hafnium oxide or hafnium nitride.

Each cycle of the ALD process includes exposing the aerospace component to the second precursor, conducting a pump-purge, exposing the aerospace component to the second reactant, and conducting a pump-purge to form the second deposited layer. The order of the second precursor and the second reactant can be reversed, such that the ALD cycle includes exposing the surface of the aerospace component to the second reactant, conducting a pump-purge, exposing the aerospace component to the second precursor, and conducting a pump-purge to form the second deposited layer.

In one or more examples, during each ALD cycle, the aerospace component is exposed to the second precursor for about 0.1 seconds to about 10 seconds, the second reactant for about 0.1 seconds to about 10 seconds, and the pump-purge for about 0.5 seconds to about 30 seconds. In other examples, during each ALD cycle, the aerospace component is exposed to the second precursor for about 0.5 seconds to about 3 seconds, the second reactant for about 0.5 seconds to about 3 seconds, and the pump-purge for about 1 second to about 10 seconds.

Each ALD cycle is repeated from 2, 3, 4, 5, 6, 8, about 10, about 12, or about 15 times to about 18, about 20, about 25, about 30, about 40, about 50, about 65, about 80, about 100, about 120, about 150, about 200, about 250, about 300, about 350, about 400, about 500, about 800, about 1,000, or more times to form the second deposited layer. For example, each ALD cycle is repeated from 2 times to about 1,000 times, 2 times to about 800 times, 2 times to about 500 times, 2 times to about 300 times, 2 times to about 250 times, 2 times to about 200 times, 2 times to about 150 times, 2 times to about 120 times, 2 times to about 100 times, 2 times to about 80 times, 2 times to about 50 times, 2 times to about 30 times, 2 times to about 20 times, 2 times to about 15 times, 2 times to about 10 times, 2 times to 5 times, about 8 times to about 1,000 times, about 8 times to about 800 times, about 8 times to about 500 times, about 8 times to about 300 times, about 8 times to about 250 times, about 8 times to about 200 times, about 8 times to about 150 times, about 8 times to about 120 times, about 8 times to about 100 times, about 8 times to about 80 times, about 8 times to about 50 times, about 8 times to about 30 times, about 8 times to about 20 times, about 8 times to about 15 times, about 8 times to about 10 times, about 20 times to about 1,000 times, about 20 times to about 800 times, about 20 times to about 500 times, about 20 times to about 300 times, about 20 times to about 250 times, about 20 times to about 200 times, about 20 times to about 150 times, about 20 times to about 120 times, about 20 times to about 100 times, about 20 times to about 80 times, about 20 times to about 50 times, about 20 times to about 30 times, about 50 times to about 1,000 times, about 50 times to about 500 times, about 50 times to about 350 times, about 50 times to about 300 times, about 50 times to about 250 times, about 50 times to about 150 times, or about 50 times to about 100 times to form the second deposited layer.

The second deposited layer can have a thickness of about 0.1 nm, about 0.2 nm, about 0.3 nm, about 0.4 nm, about 0.5 nm, about 0.8 nm, about 1 nm, about 2 nm, about 3 nm, about 5 nm, about 8 nm, about 10 nm, about 12 nm, or about 15 nm to about 18 nm, about 20 nm, about 25 nm, about 30 nm, about 40 nm, about 50 nm, about 60 nm, about 80 nm, about 100 nm, about 120 nm, or about 150 nm. For example, the second deposited layer can have a thickness of about 0.1 nm to about 150 nm, about 0.2 nm to about 150 nm, about 0.2 nm to about 120 nm, about 0.2 nm to about 100 nm, about 0.2 nm to about 80 nm, about 0.2 nm to about 50 nm, about 0.2 nm to about 40 nm, about 0.2 nm to about 30 nm, about 0.2 nm to about 20 nm, about 0.2 nm to about 10 nm, about 0.2 nm to about 5 nm, about 0.2 nm to about 1 nm, about 0.2 nm to about 0.5 nm, about 0.5 nm to about 150 nm, about 0.5 nm to about 120 nm, about 0.5 nm to about 100 nm, about 0.5 nm to about 80 nm, about 0.5 nm to about 50 nm, about 0.5 nm to about 40 nm, about 0.5 nm to about 30 nm, about 0.5 nm to about 20 nm, about 0.5 nm to about 10 nm, about 0.5 nm to about 5 nm, about 0.5 nm to about 1 nm, about 2 nm to about 150 nm, about 2 nm to about 120 nm, about 2 nm to about 100 nm, about 2 nm to about 80 nm, about 2 nm to about 50 nm, about 2 nm to about 40 nm, about 2 nm to about 30 nm, about 2 nm to about 20 nm, about 2 nm to about 10 nm, about 2 nm to about 5 nm, about 2 nm to about 3 nm, about 10 nm to about 150 nm, about 10 nm to about 120 nm, about 10 nm to about 100 nm, about 10 nm to about 80 nm, about 10 nm to about 50 nm, about 10 nm to about 40 nm, about 10 nm to about 30 nm, about 10 nm to about 20 nm, or about 10 nm to about 15 nm.

In some examples, the first deposited layer is a chromium-containing layer that contains chromium oxide, chromium nitride, or a combination thereof, and the second deposited layer contains one or more of aluminum oxide, silicon nitride, hafnium oxide, hafnium silicate, titanium oxide, or any combination thereof.

In one or more embodiments, the protective coating or the nanolaminate film stack can contain from 1, 2, 3, 4, 5, 6, 7, 8, or 9 pairs of the first and second deposited layers to about 10, about 12, about 15, about 20, about 25, about 30, about 40, about 50, about 65, about 80, about 100, about 120, about 150, about 200, about 250, about 300, about 500, about 800, or about 1,000 pairs of the first and second deposited layers. For example, the nanolaminate film stack can contain from 1 to about 1,000, 1 to about 800, 1 to about 500, 1 to about 300, 1 to about 250, 1 to about 200, 1 to about 150, 1 to about 120, 1 to about 100, 1 to about 80, 1 to about 65, 1 to about 50, 1 to about 30, 1 to about 20, 1 to about 15, 1 to about 10, 1 to about 8, 1 to about 6, 1 to 5, 1 to 4, 1 to 3, about 5 to about 150, about 5 to about 120, about 5 to about 100, about 5 to about 80, about 5 to about 65, about 5 to about 50, about 5 to about 30, about 5 to about 20, about 5 to about 15, about 5 to about 10, about 5 to about 8, about 5 to about 7, about 10 to about 150, about 10 to about 120, about 10 to about 100, about 10 to about 80, about 10 to about 65, about 10 to about 50, about 10 to about 30, about 10 to about 20, about 10 to about 15, or about 10 to about 12 pairs of the first and second deposited layers.

The protective coating or the nanolaminate film stack can have a thickness of about 1 nm, about 2 nm, about 3 nm, about 5 nm, about 8 nm, about 10 nm, about 12 nm, about 15 nm, about 20 nm, about 30 nm, about 50 nm, about 60 nm, about 80 nm, about 100 nm, or about 120 nm to about 150 nm, about 180 nm, about 200 nm, about 250 nm, about 300 nm, about 350 nm, about 400 nm, about 500 nm, about 800 nm, about 1,000 nm, about 2,000 nm, about 3,000 nm, about 4,000 nm, about 5,000 nm, about 6,000 nm, about 7,000 nm, about 8,000 nm, about 9,000 nm, about 10,000 nm, or thicker. In some examples, the protective coating or the nanolaminate film stack can have a thickness of less than 10 μm (less than 10,000 nm). For example, the protective coating or the nanolaminate film stack can have a thickness of about 1 nm to less than 10,000 nm, about 1 nm to about 8,000 nm, about 1 nm to about 6,000 nm, about 1 nm to about 5,000 nm, about 1 nm to about 3,000 nm, about 1 nm to about 2,000 nm, about 1 nm to about 1,500 nm, about 1 nm to about 1,000 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 50 nm, about 20 nm to about 500 nm, about 20 nm to about 400 nm, about 20 nm to about 300 nm, about 20 nm to about 250 nm, about 20 nm to about 200 nm, about 20 nm to about 150 nm, about 20 nm to about 100 nm, about 20 nm to about 80 nm, about 20 nm to about 50 nm, about 30 nm to about 400 nm, about 30 nm to about 200 nm, about 50 nm to about 500 nm, about 50 nm to about 400 nm, about 50 nm to about 300 nm, about 50 nm to about 250 nm, about 50 nm to about 200 nm, about 50 nm to about 150 nm, about 50 nm to about 100 nm, about 80 nm to about 250 nm, about 80 nm to about 200 nm, about 80 nm to about 150 nm, about 80 nm to about 100 nm, about 50 nm to about 80 nm, about 100 nm to about 500 nm, about 100 nm to about 400 nm, about 100 nm to about 300 nm, about 100 nm to about 250 nm, about 100 nm to about 200 nm, or about 100 nm to about 150 nm.

In some embodiments, the nanolaminate film stack can optionally be exposed to one or more annealing processes. In some examples, the nanolaminate film stack can be converted into the coalesced film or crystalline film during the annealing process. During the annealing process, the high temperature coalesces the layers within the nanolaminate film stack into a single structure where the new crystalline assembly enhances the integrity and protective properties of the coalesced film or crystalline film. In other examples, the nanolaminate film stack can be heated and densified during the annealing process, but still maintained as a nanolaminate film stack. The annealing process can be or include a thermal anneal, a plasma anneal, an ultraviolet anneal, a laser anneal, or any combination thereof.

The nanolaminate film stack disposed on the aerospace component is heated to a temperature of about 400° C., about 500° C., about 600° C., or about 700° C. to about 750° C., about 800° C., about 900° C., about 1,000° C., about 1,100° C., about 1,200° C., or greater during the annealing process. For example, the nanolaminate film stack disposed on the aerospace component is heated to a temperature of about 400° C. to about 1,200° C., about 400° C. to about 1,100° C., about 400° C. to about 1,000° C., about 400° C. to about 900° C., about 400° C. to about 800° C., about 400° C. to about 700° C., about 400° C. to about 600° C., about 400° C. to about 500° C., about 550° C. to about 1,200° C., about 550° C. to about 1,100° C., about 550° C. to about 1,000° C., about 550° C. to about 900° C., about 550° C. to about 800° C., about 550° C. to about 700° C., about 550° C. to about 600° C., about 700° C. to about 1,200° C., about 700° C. to about 1,100° C., about 700° C. to about 1,000° C., about 700° C. to about 900° C., about 700° C. to about 800° C., about 850° C. to about 1,200° C., about 850° C. to about 1,100° C., about 850° C. to about 1,000° C., or about 850° C. to about 900° C. during the annealing process.

The nanolaminate film stack can be under a vacuum at a low pressure (e.g., from about 0.1 Torr to less than 760 Torr), at ambient pressure (e.g., about 760 Torr), and/or at a high pressure (e.g., from greater than 760 Torr (1 atm) to about 3,678 Torr (about 5 atm)) during the annealing process. The nanolaminate film stack can be exposed to an atmosphere containing one or more gases during the annealing process. Exemplary gases used during the annealing process can be or include nitrogen (N₂), argon, helium, hydrogen (H₂), oxygen (O₂), or any combinations thereof. The annealing process can be performed for about 0.01 seconds to about 10 minutes. In some examples, the annealing process can be a thermal anneal and lasts for about 1 minute, about 5 minutes, about 10 minutes, or about 30 minutes to about 1 hour, about 2 hours, about 5 hours, or about 24 hours. In other examples, the annealing process can be a laser anneal or a spike anneal and lasts for about 1 millisecond, about 100 millisecond, or about 1 second to about 5 seconds, about 10 seconds, or about 15 seconds.

The protective coating or the coalesced film or crystalline film can have a thickness of about 1 nm, about 2 nm, about 3 nm, about 5 nm, about 8 nm, about 10 nm, about 12 nm, about 15 nm, about 20 nm, about 30 nm, about 50 nm, about 60 nm, about 80 nm, about 100 nm, or about 120 nm to about 150 nm, about 180 nm, about 200 nm, about 250 nm, about 300 nm, about 350 nm, about 400 nm, about 500 nm, about 700 nm, about 850 nm, about 1,000 nm, about 1,200 nm, about 1,500 nm, about 2,000 nm, about 3,000 nm, about 4,000 nm, about 5,000 nm, about 6,000 nm, about 7,000 nm, about 8,000 nm, about 9,000 nm, about 10,000 nm, or thicker. In some examples, the protective coating or the coalesced film or crystalline film can have a thickness of less than 10 μm (less than 10,000 nm). For example, the protective coating or the coalesced film or crystalline film can have a thickness of about 1 nm to less than 10,000 nm, about 1 nm to about 8,000 nm, about 1 nm to about 6,000 nm, about 1 nm to about 5,000 nm, about 1 nm to about 3,000 nm, about 1 nm to about 2,000 nm, about 1 nm to about 1,500 nm, about 1 nm to about 1,000 nm, about 1 nm to about 500 nm, about 1 nm to about 400 nm, about 1 nm to about 300 nm, about 1 nm to about 250 nm, about 1 nm to about 200 nm, about 1 nm to about 150 nm, about 1 nm to about 100 nm, about 1 nm to about 80 nm, about 1 nm to about 50 nm, about 20 nm to about 500 nm, about 20 nm to about 400 nm, about 20 nm to about 300 nm, about 20 nm to about 250 nm, about 20 nm to about 200 nm, about 20 nm to about 150 nm, about 20 nm to about 100 nm, about 20 nm to about 80 nm, about 20 nm to about 50 nm, about 30 nm to about 400 nm, about 30 nm to about 200 nm, about 50 nm to about 500 nm, about 50 nm to about 400 nm, about 50 nm to about 300 nm, about 50 nm to about 250 nm, about 50 nm to about 200 nm, about 50 nm to about 150 nm, about 50 nm to about 100 nm, about 80 nm to about 250 nm, about 80 nm to about 200 nm, about 80 nm to about 150 nm, about 80 nm to about 100 nm, about 50 nm to about 80 nm, about 100 nm to about 500 nm, about 100 nm to about 400 nm, about 100 nm to about 300 nm, about 100 nm to about 250 nm, about 100 nm to about 200 nm, or about 100 nm to about 150 nm.

In one or more embodiments, the protective coating can have a relatively high degree of uniformity. The protective coating can have a uniformity of less than 50%, less than 40%, or less than 30% of the thickness of the respective protective coating. The protective coating can have a uniformity from about 0%, about 0.5%, about 1%, about 2%, about 3%, about 5%, about 8%, or about 10% to about 12%, about 15%, about 18%, about 20%, about 22%, about 25%, about 28%, about 30%, about 35%, about 40%, about 45%, or less than 50% of the thickness. For example, the protective coating can have a uniformity from about 0% to about 50%, about 0% to about 40%, about 0% to about 30%, about 0% to less than 30%, about 0% to about 28%, about 0% to about 25%, about 0% to about 20%, about 0% to about 15%, about 0% to about 10%, about 0% to about 8%, about 0% to about 5%, about 0% to about 3%, about 0% to about 2%, about 0% to about 1%, about 1% to about 50%, about 1% to about 40%, about 1% to about 30%, about 1% to less than 30%, about 1% to about 28%, about 1% to about 25%, about 1% to about 20%, about 1% to about 15%, about 1% to about 10%, about 1% to about 8%, about 1% to about 5%, about 1% to about 3%, about 1% to about 2%, about 5% to about 50%, about 5% to about 40%, about 5% to about 30%, about 5% to less than 30%, about 5% to about 28%, about 5% to about 25%, about 5% to about 20%, about 5% to about 15%, about 5% to about 10%, about 5% to about 8%, about 10% to about 50%, about 10% to about 40%, about 10% to about 30%, about 10% to less than 30%, about 10% to about 28%, about 10% to about 25%, about 10% to about 20%, about 10% to about 15%, or about 10% to about 12% of the thickness.

In some embodiments, the protective coating can contain, be formed with, or otherwise produced with different ratios of metals throughout the material, such as one or more doping metals and/or one or more grading metals contained within a base metal, where any of the metals can be in any chemically oxidized form or state (e.g., oxide, nitride, silicide, carbide, or combinations thereof). In one or more examples, the first deposited layer is deposited to first thickness and the second deposited layer is deposited to a second thickness. The first thickness can be the same as the second thickness or the first thickness can be different than (less than or greater than) the second thickness. For example, the first deposited layer can be deposited by two or more (3, 4, 5, 6, 7, 8, 9, 10, or more) ALD cycles to produce the respectively same amount of sub-layers (e.g., one sub-layer for each ALD cycle), and then the second deposited layer can be deposited by one ALD cycle or a number of ALD cycles that is less than or greater than the number of ALD cycles used to deposit the first deposited layer. In other examples, the first deposited layer can be deposited by CVD to a first thickness and the second deposited layer is deposited by ALD to a second thickness which is less than the first thickness.

In other embodiments, an ALD process can be used to deposit the first deposited layer and/or the second deposited layer where the deposited material is doped by including a dopant precursor during the ALD process. In some examples, the dopant precursor can be included in a separate ALD cycle relative to the ALD cycles used to deposit the base material. In other examples, the dopant precursor can be co-injected with any of the chemical precursors used during the ALD cycle. In further examples, the dopant precursor can be injected separately from the chemical precursors during the ALD cycle. For example, one ALD cycle can include exposing the aerospace component to: the first precursor, a pump-purge, the dopant precursor, a pump-purge, the first reactant, and a pump-purge to form the deposited layer. In some examples, one ALD cycle can include exposing the aerospace component to: the dopant precursor, a pump-purge, the first precursor, a pump-purge, the first reactant, and a pump-purge to form the deposited layer. In other examples, one ALD cycle can include exposing the aerospace component to: the first precursor, the dopant precursor, a pump-purge, the first reactant, and a pump-purge to form the deposited layer.

In one or more embodiments, the first deposited layer and/or the second deposited layer contains one or more base materials and one or more doping materials. The base material is or contains aluminum oxide, chromium oxide, or a combination of aluminum oxide and chromium oxide. The doping material is or contains hafnium, hafnium oxide, yttrium, yttrium oxide, cerium, cerium oxide, silicon, silicon oxide, nitrides thereof, or any combination thereof. Any of the precursors or reagents described herein can be used as a doping precursor or a dopant. Exemplary cerium precursor can be or include one or more cerium(IV) tetra(2,2,6,6-tetramethyl-3,5-heptanedionate) (Ce(TMHD)₄), tris(cyclopentadiene) cerium ((C₅H₅)₃Ce), tris(propylcyclopentadiene) cerium ([(C₃H₇)C₅H₄]₃Ce), tris(tetramethylcyclopentadiene) cerium ([(CH₃)₄C₅H]₃Ce), or any combination thereof.

The doping material can have a concentration of about 0.01 atomic percent (at %), about 0.05 at %, about 0.08 at %, about 0.1 at %, about 0.5 at %, about 0.8 at %, about 1 at %, about 1.2 at %, about 1.5 at %, about 1.8 at %, or about 2 at % to about 2.5 at %, about 3 at %, about 3.5 at %, about 4 at %, about 5 at %, about 8 at %, about 10 at %, about 15 at %, about 20 at %, about 25 at %, or about 30 at % within the first deposited layer, the second deposited layer, the nanolaminate film stack, and/or the coalesced film or crystalline film. For example, the doping material can have a concentration of about 0.01 at % to about 30 at %, about 0.01 at % to about 25 at %, about 0.01 at % to about 20 at %, about 0.01 at % to about 15 at %, about 0.01 at % to about 12 at %, about 0.01 at % to about 10 at %, about 0.01 at % to about 8 at %, about 0.01 at % to about 5 at %, about 0.01 at % to about 4 at %, about 0.01 at % to about 3 at %, about 0.01 at % to about 2.5 at %, about 0.01 at % to about 2 at %, about 0.01 at % to about 1.5 at %, about 0.01 at % to about 1 at %, about 0.01 at % to about 0.5 at %, about 0.01 at % to about 0.1 at %, about 0.1 at % to about 30 at %, about 0.1 at % to about 25 at %, about 0.1 at % to about 20 at %, about 0.1 at % to about 15 at %, about 0.1 at % to about 12 at %, about 0.1 at % to about 10 at %, about 0.1 at % to about 8 at %, about 0.1 at % to about 5 at %, about 0.1 at % to about 4 at %, about 0.1 at % to about 3 at %, about 0.1 at % to about 2.5 at %, about 0.1 at % to about 2 at %, about 0.1 at % to about 1.5 at %, about 0.1 at % to about 1 at %, about 0.1 at % to about 0.5 at %, about 1 at % to about 30 at %, about 1 at % to about 25 at %, about 1 at % to about 20 at %, about 1 at % to about 15 at %, about 1 at % to about 12 at %, about 1 at % to about 10 at %, about 1 at % to about 8 at %, about 1 at % to about 5 at %, about 1 at % to about 4 at %, about 1 at % to about 3 at %, about 1 at % to about 2.5 at %, about 1 at % to about 2 at %, or about 1 at % to about 1.5 at % within the first deposited layer, the second deposited layer, the nanolaminate film stack, and/or the coalesced film or crystalline film.

In one or more embodiments, the protective coating includes the nanolaminate film stack having the first deposited layer containing aluminum oxide (or other base material) and the second deposited layer containing hafnium oxide (or other doping material), or having the first deposited layer containing hafnium oxide (or other doping material) and the second deposited layer containing aluminum oxide (or other base material). In one or more examples, the protective coating contains a combination of aluminum oxide and hafnium oxide, a hafnium-doped aluminum oxide, hafnium aluminate, or any combination thereof. For example, the protective coating includes the nanolaminate film stack having the first deposited layer containing aluminum oxide and the second deposited layer containing hafnium oxide, or having the first deposited layer containing hafnium oxide and the second deposited layer contains aluminum oxide. In other examples, the protective coating includes the coalesced film or crystalline film formed from layers of aluminum oxide and hafnium oxide. In one or more embodiments, the protective coating has a concentration of hafnium (or other doping material) of about 0.01 at %, about 0.05 at %, about 0.08 at %, about 0.1 at %, about 0.5 at %, about 0.8 at %, or about 1 at % to about 1.2 at %, about 1.5 at %, about 1.8 at %, about 2 at %, about 2.5 at %, about 3 at %, about 3.5 at %, about 4 at %, about 4.5 at %, or about 5 at % within the nanolaminate film stack or the coalesced film or crystalline film containing aluminum oxide (or other base material). For example, the protective coating has a concentration of hafnium (or other doping material) of about 0.01 at % to about 10 at %, about 0.01 at % to about 8 at %, about 0.01 at % to about 5 at %, about 0.01 at % to about 4 at %, about 0.01 at % to about 3 at %, about 0.01 at % to about 2.5 at %, about 0.01 at % to about 2 at %, about 0.01 at % to about 1.5 at %, about 0.01 at % to about 1 at %, about 0.01 at % to about 0.5 at %, about 0.01 at % to about 0.1 at %, about 0.01 at % to about 0.05 at %, about 0.1 at % to about 5 at %, about 0.1 at % to about 4 at %, about 0.1 at % to about 3 at %, about 0.1 at % to about 2.5 at %, about 0.1 at % to about 2 at %, about 0.1 at % to about 1.5 at %, about 0.1 at % to about 1 at %, about 0.1 at % to about 0.5 at %, about 0.5 at % to about 5 at %, about 0.5 at % to about 4 at %, about 0.5 at % to about 3 at %, about 0.5 at % to about 2.5 at %, about 0.5 at % to about 2 at %, about 0.5 at % to about 1.5 at %, about 0.5 at % to about 1 at %, about 1 at % to about 5 at %, about 1 at % to about 4 at %, about 1 at % to about 3 at %, about 1 at % to about 2.5 at %, about 1 at % to about 2 at %, or about 1 at % to about 1.5 at % within the nanolaminate film stack or the coalesced film or crystalline film containing aluminum oxide (or other base material).

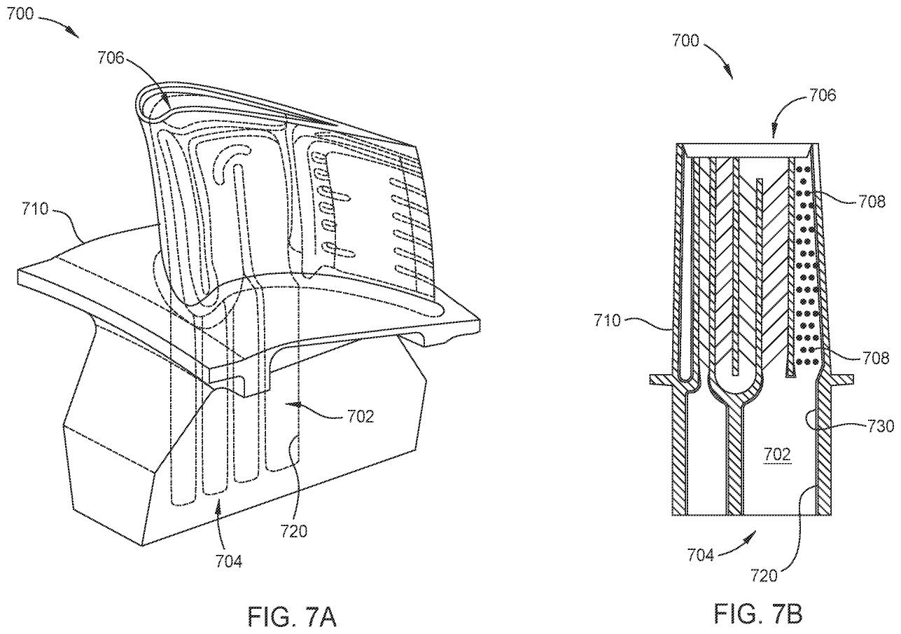

FIGS. 7A and 7B are schematic views of an aerospace component 700 containing a protective coating 730, according to one or more embodiments described and discussed herein. FIG. 7A is a perspective view of the aerospace component 700 and FIG. 7B is a cross-sectional view of the aerospace component 700. The protective coating 730 can be or include the protective coating 140 (FIGS. 1C, 3D, and 5D). Similarly, the aerospace component 700 can be or include the substrate or aerospace component 110 (FIGS. 1A-1C, 3A-3D, and 5A-5D). The refurbished aerospace component 110 or 700 can be refurbished, repaired, formed, or otherwise produced by any one of the methods described and discussed herein.

Although the aerospace component 700 is illustrated as a turbine blade in FIGS. 7A and 7B, the methods described and discussed here can be conducted or performed on other types of aerospace components, as well as other types of substrates and devices. Aerospace components as described and discussed herein, including the aerospace component 700, can be or include one or more components, parts, or portions thereof of a turbine, an aircraft, a spacecraft, a windmill, a ground-based power generation system, a fuel system, or other devices that can include one or more turbines (e.g., generators, compressors, pumps, turbo fans, super chargers, and the like). Exemplary aerospace components 700 and substrates or aerospace components 110 can be or include a turbine blade, a turbine blade root (e.g., fir tree or dovetail), a turbine disk, a turbine vane, a support member, a frame, a rib, a fin, a pin fin, a fuel nozzle, a combustor liner, a combustor shield, a heat exchanger, a fuel line, a fuel valve, any other part or portion that is exposed to a fuel (e.g., aviation fuel or jet fuel), an internal cooling channel, or any other aerospace component or part that can benefit from having a protective coating deposited thereon, or any combination thereof. The aerospace component 110, 700 typically has a thickness of about 1 mm, about 1.5 mm, or about 2 mm to about 3 mm, about 5 mm, about 8 mm, or about 10 mm. For example, the aerospace component 110, 700 can have a thickness of about 1 mm to about 5 mm or about 2 mm to about 3 mm.

The aerospace component 700 has one or more outer or exterior surfaces 710 and one or more inner or interior surfaces 720. The interior surfaces 720 can define one or more cavities 702 extending or contained within the aerospace component 700. The cavities 702 can be channels, passages, spaces, or the like disposed between the interior surfaces 720. The cavity 702 can have one or more openings 704, 706, and 708. Each of the cavities 702 within the aerospace component 700 typically have aspect ratios (e.g., length divided by width) of greater than 1. The methods described and discussed herein provide cleaning surfaces within the cavities 702, as well as depositing and/or otherwise forming the protective coating 730 on the interior surfaces 720, including cleaned surfaces, within these cavities 702 having high aspect ratios (greater than 1).

The aspect ratio of the cavity 702 can be from about 2, about 3, about 5, about 8, about 10, or about 12 to about 15, about 20, about 25, about 30, about 40, about 50, about 65, about 80, about 100, about 120, about 150, about 200, about 250, about 300, about 500, about 800, about 1,000, or greater. For example, the aspect ratio of the cavity 702 can be from about 2 to about 1,000, about 2 to about 500, about 2 to about 200, about 2 to about 150, about 2 to about 120, about 2 to about 100, about 2 to about 80, about 2 to about 50, about 2 to about 40, about 2 to about 30, about 2 to about 20, about 2 to about 10, about 2 to about 8, about 5 to about 1,000, about 5 to about 500, about 5 to about 200, about 5 to about 150, about 5 to about 120, about 5 to about 100, about 5 to about 80, about 5 to about 50, about 5 to about 40, about 5 to about 30, about 5 to about 20, about 5 to about 10, about 5 to about 8, about 10 to about 1,000, about 10 to about 500, about 10 to about 200, about 10 to about 150, about 10 to about 120, about 10 to about 100, about 10 to about 80, about 10 to about 50, about 10 to about 40, about 10 to about 30, about 10 to about 20, about 20 to about 1,000, about 20 to about 500, about 20 to about 200, about 20 to about 150, about 20 to about 120, about 20 to about 100, about 20 to about 80, about 20 to about 50, about 20 to about 40, or about 20 to about 30.

The aerospace component 700 and any surface thereof including one or more outer or exterior surfaces 710 and/or one or more inner or interior surfaces 720 can be made of, contain, or otherwise include one or more metals, such as nickel, one or more nickel superalloys, one or more nickel-aluminum alloys, aluminum, iron, one or more stainless steels, cobalt, chromium, molybdenum, titanium, CMSX® superalloys (e.g., CMSX®-2, CMSX®-4, CMSX®-4+, or CMSX®-10 superalloys, commercially from Cannon-Muskegon Corporation), one or more Inconel alloys, one or more Hastelloy alloys, one or more Invar alloys, one or more Inovoco alloys, alloys thereof, or any combination thereof. In one or more embodiments, the main body of the aerospace component 700 contains nickel, such as a nickel alloy or a nickel superalloy. On the outer or exterior surfaces 710 and/or the inner or interior surfaces 720, the aerospace component 700 can have one or more aluminide layers disposed on the nickel superalloy and one or more aluminum oxide layers disposed on the aluminide layer. The protective coating 730 can be deposited, formed, or otherwise produced on any surface of the aerospace component 700 including the aluminum oxide layer and/or the aluminide layer on the outer or exterior surfaces 710 and/or the inner or interior surfaces 720.

The protective coating, as described and discussed herein, can be or include one or more of laminate film stacks, coalesced films, crystalline film, graded compositions, and/or monolithic films which are deposited or otherwise formed on any surface of an aerospace component. In some examples, the protective coating contains from about 1% to about 100% chromium oxide. The protective coating is conformal and substantially coat rough surface features following surface topology, including in open pores, blind holes, and non-line-of sight regions of a surface. The protective coating does not substantially increase surface roughness, and in some embodiments, the protective coating may reduce surface roughness by conformally coating roughness until it coalesces. The protective coating may contain particles from the deposition that are substantially larger than the roughness of the aerospace component, but are considered separate from the monolithic film. The protective coating is substantially well adhered and pinhole free. The thicknesses of the protective coating can vary within 1-sigma of 40%. In one or more embodiments, the thickness varies less than 1-sigma of 20%, 10%, 5%, 1% or 0.1%.

The protective coating provides corrosion and oxidation protection when the aerospace components are exposed to air, oxygen, sulfur and/or sulfur compounds, acids, bases, salts (e.g., Na, K, Mg, Li, or Ca salts), or any combination thereof. In some embodiments, protective coating provides protection against coke deposition. The aerospace component may be exposed to these conditions during normal operation or during a cleaning process to remove any carbon buildup from the protective coating. In one or more embodiments, the protective coating reduces or suppresses coke formation when the aerospace component is heated in the presence of a fuel, such as an aviation fuel, jet fuel, kerosene, or the like. In some examples, the protective coating can be or include one or more material, such as aluminum oxide, aluminum nitride, aluminum oxynitride, silicon oxide, silicon nitride, silicon oxynitride, chromium oxide, tantalum oxide, tantalum nitride, tantalum oxynitride, alloys thereof, or any combination thereof.

One or more embodiments described herein include methods for the preservation of an underneath chromium-containing alloy using the methods producing an alternating nanolaminate of first material (e.g., chromium oxide, aluminum oxide, and/or aluminum nitride) and another secondary material. The secondary material can be or include one or more of aluminum oxide, aluminum nitride, aluminum oxynitride, silicon oxide, silicon nitride, silicon carbide, yttrium oxide, yttrium nitride, yttrium silicon nitride, hafnium oxide, hafnium silicate, hafnium silicide, hafnium nitride, titanium oxide, titanium nitride, titanium silicide, titanium silicate, tantalum oxide, tantalum nitride, tantalum silicide, tantalum silicate, dopants thereof, alloys thereof, or any combination thereof. The resultant film can be used as a nanolaminate film stack or the film can be subjected to annealing where the high temperature coalesces the films into a single structure where the new crystalline assembly enhances the integrity and protective properties of this overlying film.

In a particular embodiment, the chromium precursor (at a temperature of about 0° C. to about 250° C.) is delivered to the aerospace component via vapor phase delivery for at pre-determined pulse length of about 5 seconds. During this process, the deposition reactor is operated under a flow of nitrogen carrier gas (about 1,000 sccm total) with the chamber held at a pre-determined temperature of about 350° C. and pressure of about 3.5 Torr. After the pulse of the chromium precursor, the chamber is then subsequently pumped and purged of all requisite gases and byproducts for a determined amount of time. Subsequently, water (or another oxidizing agent) is pulsed into the chamber for about 0.1 seconds at chamber pressure of about 3.5 Torr. An additional chamber purge (or pump/purge) is then performed to rid the reactor of any excess reactants and reaction byproducts. This process is repeated as many times as necessary to get the target chromium oxide film to the desired film thickness.

For the secondary film (example: aluminum oxide), the precursor, trimethylaluminum (at a temperature of about 0° C. to about 30° C.) is delivered to the aerospace component via vapor phase delivery for at pre-determined pulse length of about 0.1 seconds. During this process, the deposition reactor is operated under a flow of nitrogen carrier gas (about 100 sccm total) with the chamber held at a pre-determined temperature of about 150° C. to about 350° C. and pressure about 1 Torr to about 5 Torr. After the pulse of trimethylaluminum, the chamber is then subsequently pumped and purged of all requisite gases and byproducts for a determined amount of time. Subsequently, water vapor is pulsed into the chamber for about 0.1 seconds at chamber pressure of about 3.5 Torr. An additional chamber purge is then performed to rid the reactor of any excess reactants and reaction byproducts. This process is repeated as many times as necessary to get the target aluminum oxide film to the desired film thickness. The aerospace component is then subjected to an annealing furnace at a temperature of about 500° C. under inert nitrogen flow of about 500 sccm for about one hour.

The methods described and discussed herein provide refurbished aerospace components. The methods are utilized to remove corrosion from the aerospace components, and in some examples, remove minimum amounts of protective coatings which contain corrosion, and thereafter, deposit or otherwise form a protective coating on the cleaned aerospace component. The method includes using an aqueous cleaning solution and/or an acidic cleaning solution to remove the corrosion prior to depositing the protective coating. The protective coatings: (1) protect metals from oxidation and corrosion, (2) are capable of relatively high film thickness and composition uniformity on arbitrary geometries, (3) have relatively high adhesion to the metal, (4) are sufficiently thin to not materially increase weight or reduce fatigue life outside of current design practices for bare metal, and/or (5) are deposited at sufficiently low temperature (e.g., 500° C. or less) to not cause microstructural changes to the metal.

Embodiments of the present disclosure further relate to any one or more of the following examples 1-32:

1. A method for detecting an end-point of a cleaning process for an aerospace component, comprising: analyzing a reference solvent by absorbance spectroscopy to determine a reference solute concentration of the reference solvent; exposing the aerospace component to a first solvent, wherein the aerospace component comprises a nickel superalloy, an aluminide layer disposed on the nickel superalloy, and an aluminum oxide layer disposed on the aluminide layer, and wherein the corrosion is contained on the aluminum oxide layer; exposing the aerospace component to a first water rinse; analyzing a first aliquot of the first water rinse by absorbance spectroscopy to determine an intermediate solute concentration in the first aliquot, wherein the intermediate solute concentration is greater than the reference solute concentration; exposing the aerospace component containing corrosion to an aqueous cleaning solution to remove the corrosion from the aluminum oxide layer; exposing the aerospace component to a second solvent; exposing the aerospace component to a second water rinse; and analyzing a second aliquot of the second water rinse by absorbance spectroscopy to determine a post-clean solute concentration in the second aliquot, wherein the post-clean solute concentration is less than the intermediate solute concentration.

2. The method according to example 1, wherein each of the first aliquot and the second aliquot is independently analyzed by ultraviolet-visible (UV-vis) absorbance spectroscopy.

3. The method according to example 1 or 2, wherein the aqueous cleaning solution comprises water, a complexing agent, and a base.

4. The method according to any one of examples 1-3, wherein the complexing agent comprises ethylenediaminetetraacetic acid (EDTA) and/or a salt thereof, and wherein the base comprises a hydroxide.

5. The method according to any one of examples 1-4, further comprising: exposing the aerospace component to the aqueous cleaning solution for about 1 hour to about 5 hours; sonicating the aerospace component in the aqueous cleaning solution; and maintaining the aqueous cleaning solution at a temperature of about 20° C. to about 50° C.

6. The method according to any one of examples 1-5, wherein exposing the aerospace component to the first solvent further comprises: exposing the aerospace component to the first solvent for about 5 minutes to about 60 minutes; sonicating the aerospace component in the first solvent; and maintaining the first solvent at a temperature of about 20° C. to about 50° C.

7. The method according to any one of examples 1-6, wherein the first solvent comprises an organic solvent and water.

8. The method according to any one of examples 1-7, wherein exposing the aerospace component to the second solvent further comprises: exposing the aerospace component to the second solvent for about 5 minutes to about 60 minutes; sonicating the aerospace component in the second solvent; and maintaining the second solvent at a temperature of about 20° C. to about 50° C.

9. The method according to any one of examples 1-8, wherein the second solvent comprises an organic solvent and water.

10. The method according to any one of examples 1-9, wherein the aluminide layer comprises nickel aluminide, titanium aluminide, magnesium aluminide, iron aluminide, or combinations thereof.

11. The method according to any one of examples 1-10, wherein the aluminide layer has a thickness of about 20 μm to about 500 μm.

12. The method according to any one of examples 1-11, wherein the aluminum oxide has a thickness of about 1 μm to about 50 μm.

13. The method according to any one of examples 1-12, wherein the aerospace component has a thickness of about 1 mm to about 5 mm.

14. A method for detecting an end-point of a cleaning process for an aerospace component, comprising: analyzing a reference solvent by absorbance spectroscopy to determine a reference solute concentration of the reference solvent; exposing the aerospace component to a first solvent, wherein the aerospace component comprises a nickel superalloy, an aluminide layer disposed on the nickel superalloy, and an aluminum oxide layer disposed on the aluminide layer, and wherein the corrosion is contained within at least one of the aluminum oxide layer or the aluminide layer; exposing the aerospace component to a first water rinse; analyzing a first aliquot of the first water rinse by absorbance spectroscopy to determine a first intermediate solute concentration in the first aliquot, wherein the first intermediate solute concentration is greater than the reference solute concentration; exposing the aerospace component to a first aqueous cleaning solution to remove the corrosion from the aluminum oxide layer; exposing the aerospace component to a first sonication in water; exposing the aerospace component to a second water rinse; and analyzing a second aliquot of the second water rinse by absorbance spectroscopy to determine a second intermediate solute concentration in the second aliquot, wherein the second intermediate solute concentration is less than the first intermediate solute concentration; exposing the aerospace component to an acidic cleaning solution to remove the corrosion from the aluminum oxide layer and/or or the aluminide layer; exposing the aerospace component to a second sonication in water; exposing the aerospace component to a third water rinse; and analyzing a third aliquot of the third water rinse by absorbance spectroscopy to determine a third intermediate solute concentration in the third aliquot, wherein the third intermediate solute concentration is less than the second intermediate solute concentration; exposing the aerospace component to a second aqueous cleaning solution to remove the corrosion from the aluminum oxide layer and/or or the aluminide layer; exposing the aerospace component to a second solvent; exposing the aerospace component to a fourth water rinse; and analyzing a fourth aliquot of the fourth water rinse by absorbance spectroscopy to determine a post-clean solute concentration in the fourth aliquot, wherein the post-clean solute concentration is less than the third intermediate solute concentration.

15. The method according to example 14, wherein each of the first aliquot, the second aliquot, the third aliquot, and the fourth aliquot is independently analyzed by ultraviolet-visible (UV-vis) absorbance spectroscopy.

16. The method according to example 14 or 15, wherein the acidic cleaning solution comprises water and about 10 volume percent (vol %) to about 40 vol % of sulfuric acid.

17. The method according to any one of examples 14-16, further comprising: exposing the aerospace component to the acidic cleaning solution for about 30 minutes to about 90 minutes; stirring the acidic cleaning solution while exposing the aerospace component; and maintaining the acidic cleaning solution at a temperature of about 50° C. to about 150° C.

18. The method according to any one of examples 14-17, wherein the acidic cleaning solution comprises water, hydrogen fluoride, and nitric acid.

19. The method according to any one of examples 14-18, wherein the acidic cleaning solution comprises about 0.2 volume percent (vol %) to about 5 vol % of hydrogen fluoride and about 1 vol % to about 10 vol % of nitric acid.

20. The method according to any one of examples 14-19, further comprising: exposing the aerospace component to the acidic cleaning solution for about 30 minutes to about 90 minutes; stirring the acidic cleaning solution while exposing the aerospace component; and maintaining the acidic cleaning solution at a temperature of about 20° C. to about 50° C.

21. The method according to any one of examples 14-20, wherein exposing the aerospace component to the first solvent further comprises: exposing the aerospace component to the first solvent for about 5 minutes to about 60 minutes; sonicating the aerospace component in the first solvent; and maintaining the first solvent at a temperature of about 20° C. to about 50° C.

22. The method according to any one of examples 14-21, wherein the first solvent comprises an organic solvent and water.

23. The method according to any one of examples 14-22, wherein exposing the aerospace component to the second solvent further comprises: exposing the aerospace component to the second solvent for about 5 minutes to about 60 minutes; sonicating the aerospace component in the second solvent; and maintaining the second solvent at a temperature of about 20° C. to about 50° C.

24. The method according to any one of examples 14-23, wherein the second solvent comprises an organic solvent and water.

25. The method according to any one of examples 14-24, wherein each of the first sonication in water and the second sonication in water further comprises: exposing the aerospace component to deionized water for about 5 minutes to about 60 minutes; sonicating the aerospace component in the deionized water; and maintaining the deionized water at a temperature of about 20° C. to about 50° C.

26. The method according to any one of examples 14-25, wherein each of the first aqueous cleaning solution and the second aqueous cleaning solution comprises water, a complexing agent, and a base.

27. The method according to any one of examples 14-26, wherein the complexing agent comprises ethylenediaminetetraacetic acid (EDTA) and/or a salt thereof, and wherein the base comprises a hydroxide.

28. The method according to any one of examples 14-27, further comprising: exposing the aerospace component to the first or second aqueous cleaning solution for about 1 hour to about 5 hours; sonicating the aerospace component in the first or second aqueous cleaning solution; and maintaining the first or second aqueous cleaning solution at a temperature of about 20° C. to about 50° C.

29. The method according to any one of examples 14-28, wherein the aluminide layer comprises nickel aluminide, titanium aluminide, magnesium aluminide, iron aluminide, or combinations thereof.

30. The method according to any one of examples 14-29, wherein the aluminide layer has a thickness of about 20 μm to about 500 μm.

31. The method according to any one of examples 14-30, wherein the aluminum oxide has a thickness of about 1 μm to about 50 μm.

32. The method according to any one of examples 14-31, wherein the aerospace component has a thickness of about 1 mm to about 5 mm.

While the foregoing is directed to embodiments of the disclosure, other and further embodiments may be devised without departing from the basic scope thereof, and the scope thereof is determined by the claims that follow. All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise, whenever a composition, an element, or a group of elements is preceded with the transitional phrase “comprising”, it is understood that the same composition or group of elements with transitional phrases “consisting essentially of”, “consisting of”, “selected from the group of consisting of”, or “is” preceding the recitation of the composition, element, or elements and vice versa, are contemplated.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below.

What is claimed is:

1. A method for detecting an end-point of a cleaning process for an aerospace component, comprising:
analyzing a reference solvent by absorbance spectroscopy to determine a reference solute concentration of the reference solvent;
exposing the aerospace component to a first solvent, wherein the aerospace component comprises a nickel superalloy, an aluminide layer disposed on the nickel superalloy, and an aluminum oxide layer disposed on the aluminide layer, and wherein the corrosion is contained on the aluminum oxide layer;
exposing the aerospace component to a first water rinse;
analyzing a first aliquot of the first water rinse by absorbance spectroscopy to determine an intermediate solute concentration in the first aliquot, wherein the intermediate solute concentration is greater than the reference solute concentration;
exposing the aerospace component containing corrosion to an aqueous cleaning solution to remove the corrosion from the aluminum oxide layer;
exposing the aerospace component to a second solvent;
exposing the aerospace component to a second water rinse; and
analyzing a second aliquot of the second water rinse by absorbance spectroscopy to determine a post-clean solute concentration in the second aliquot, wherein the post-clean solute concentration is less than the intermediate solute concentration.

2. The method of claim 1, wherein each of the first aliquot and the second aliquot is independently analyzed by ultraviolet-visible (UV-vis) absorbance spectroscopy.

3. The method of claim 1, wherein the aqueous cleaning solution comprises water, a complexing agent, and a base, and wherein the complexing agent comprises ethylenediaminetetraacetic acid (EDTA) and/or a salt thereof, and wherein the base comprises a hydroxide.

4. The method of claim 1, wherein the aqueous cleaning solution comprises water, a complexing agent, and a base, and further comprising:
exposing the aerospace component to the aqueous cleaning solution for about 1 hour to about 5 hours;
sonicating the aerospace component in the aqueous cleaning solution; and
maintaining the aqueous cleaning solution at a temperature of about 20° C. to about 50° C.

5. The method of claim 1, wherein exposing the aerospace component to the first solvent further comprises:
exposing the aerospace component to the first solvent for about 5 minutes to about 60 minutes;
sonicating the aerospace component in the first solvent; and
maintaining the first solvent at a temperature of about 20° C. to about 50° C.

6. The method of claim 1, wherein exposing the aerospace component to the second solvent further comprises:
exposing the aerospace component to the second solvent for about 5 minutes to about 60 minutes;
sonicating the aerospace component in the second solvent; and
maintaining the second solvent at a temperature of about 20° C. to about 50° C.

7. The method of claim 1, wherein the aluminide layer comprises nickel aluminide, titanium aluminide, magnesium aluminide, iron aluminide, or combinations thereof.

8. The method of claim 1, wherein the aluminide layer has a thickness of about 20 μm to about 500 μm, wherein the aluminum oxide has a thickness of about 1 μm to about 50 μm, and wherein the aerospace component has a thickness of about 1 mm to about 5 mm.

9. A method for detecting an end-point of a cleaning process for an aerospace component, comprising:
analyzing a reference solvent by absorbance spectroscopy to determine a reference solute concentration of the reference solvent;
exposing the aerospace component to a first solvent, wherein the aerospace component comprises a nickel superalloy, an aluminide layer disposed on the nickel superalloy, and an aluminum oxide layer disposed on the aluminide layer, and wherein the corrosion is contained within at least one of the aluminum oxide layer or the aluminide layer;
exposing the aerospace component to a first water rinse;
analyzing a first aliquot of the first water rinse by absorbance spectroscopy to determine a first intermediate solute concentration in the first aliquot, wherein the first intermediate solute concentration is greater than the reference solute concentration;
exposing the aerospace component to a first aqueous cleaning solution to remove the corrosion from the aluminum oxide layer;
exposing the aerospace component to a first sonication in water;
exposing the aerospace component to a second water rinse; and
analyzing a second aliquot of the second water rinse by absorbance spectroscopy to determine a second intermediate solute concentration in the second aliquot, wherein the second intermediate solute concentration is less than the first intermediate solute concentration;
exposing the aerospace component to an acidic cleaning solution to remove the corrosion from the aluminum oxide layer and/or or the aluminide layer;
exposing the aerospace component to a second sonication in water;
exposing the aerospace component to a third water rinse; and
analyzing a third aliquot of the third water rinse by absorbance spectroscopy to determine a third intermediate solute concentration in the third aliquot, wherein the third intermediate solute concentration is less than the second intermediate solute concentration;
exposing the aerospace component to a second aqueous cleaning solution to remove the corrosion from the aluminum oxide layer and/or or the aluminide layer;
exposing the aerospace component to a second solvent;
exposing the aerospace component to a fourth water rinse; and
analyzing a fourth aliquot of the fourth water rinse by absorbance spectroscopy to determine a post-clean solute concentration in the fourth aliquot, wherein the post-clean solute concentration is less than the third intermediate solute concentration.

10. The method of claim 9, wherein each of the first aliquot, the second aliquot, the third aliquot, and the fourth aliquot is independently analyzed by ultraviolet-visible (UV-vis) absorbance spectroscopy.

11. The method of claim 9, wherein the acidic cleaning solution comprises water and about 10 volume percent (vol %) to about 40 vol % of sulfuric acid, and further comprising:
exposing the aerospace component to the acidic cleaning solution for about 30 minutes to about 90 minutes;
stirring the acidic cleaning solution while exposing the aerospace component; and
maintaining the acidic cleaning solution at a temperature of about 50° C. to about 150° C.

12. The method of claim 9, wherein the acidic cleaning solution comprises water, hydrogen fluoride, and nitric acid, and wherein the acidic cleaning solution comprises about 0.2 volume percent (vol %) to about 5 vol % of hydrogen fluoride and about 1 vol % to about 10 vol % of nitric acid.

13. The method of claim 9, wherein the acidic cleaning solution comprises water, hydrogen fluoride, and nitric acid, and further comprising:
exposing the aerospace component to the acidic cleaning solution for about 30 minutes to about 90 minutes;
stirring the acidic cleaning solution while exposing the aerospace component; and
maintaining the acidic cleaning solution at a temperature of about 20° C. to about 50° C.

14. The method of claim 9, wherein exposing the aerospace component to the first solvent further comprises:
exposing the aerospace component to the first solvent for about 5 minutes to about 60 minutes;
sonicating the aerospace component in the first solvent; and
maintaining the first solvent at a temperature of about 20° C. to about 50° C.

15. The method of claim 9, wherein exposing the aerospace component to the second solvent further comprises:
exposing the aerospace component to the second solvent for about 5 minutes to about 60 minutes;
sonicating the aerospace component in the second solvent; and
maintaining the second solvent at a temperature of about 20° C. to about 50° C.

16. The method of claim 9, wherein each of the first sonication in water and the second sonication in water further comprises:
exposing the aerospace component to deionized water for about 5 minutes to about 60 minutes;
sonicating the aerospace component in the deionized water; and
maintaining the deionized water at a temperature of about 20° C. to about 50° C.

17. The method of claim 9, wherein each of the first aqueous cleaning solution and the second aqueous cleaning solution comprises water, a complexing agent, and a base, and wherein the complexing agent comprises ethylenediaminetetraacetic acid (EDTA) and/or a salt thereof, and wherein the base comprises a hydroxide.

18. The method of claim 9, wherein each of the first aqueous cleaning solution and the second aqueous cleaning solution comprises water, a complexing agent, and a base, and further comprising:
exposing the aerospace component to the first or second aqueous cleaning solution for about 1 hour to about 5 hours;
sonicating the aerospace component in the first or second aqueous cleaning solution; and
maintaining the first or second aqueous cleaning solution at a temperature of about 20° C. to about 50° C.

19. The method of claim 9, wherein the aluminide layer comprises nickel aluminide, titanium aluminide, magnesium aluminide, iron aluminide, or combinations thereof.

20. The method of claim 9, wherein the aluminide layer has a thickness of about 20 μm to about 500 μm, wherein the aluminum oxide has a thickness of about 1 μm to about 50 μm, and wherein the aerospace component has a thickness of about 1 mm to about 5 mm.
